(19) United States
(12) Patent Application Publication
(10) Pub. No.: US 2018/0295581 A1
(43) Pub. Date: Oct. 11, 2018

(54) POWER SAVINGS DURING POSITIONING MEASUREMENTS

(71) Applicant: QUALCOMM Incorporated, San Diego, CA (US)

(72) Inventors: Parthasarathy KRISHNAMOORTHY, San Diego, CA (US); Muthukumaran DHANAPAL, San Diego, CA (US); Sai Pradeep VENKATRAMAN, Santa Clara, CA (US); Hargovind Prasad BANSAL, Hyderabad (IN); Shravan Kumar RAGHUNATHAN, San Diego, CA (US); Guttorm OPSHAUG, Redwood City, CA (US); Sarfraz Mohammed GHANI, Hyderabad (IN); Bharadwaj Kumar CHERUVU, Hyderabad (IN); Vashishth JHUNJHUNWALA, Hyderabad (IN); Ram Mohan Rao KONDA, Bapatla (IN)

(21) Appl. No.: 15/482,465

(22) Filed: Apr. 7, 2017

(51) Int. Cl. H04W 52/02; H04W 76/04

(52) U.S. Cl. CPC H04W 52/0241; H04W 4/02; H04W 76/048

(57) ABSTRACT

A method of operating a wireless device includes determining to operate the wireless device in a discontinuous reception (DRX) mode of operation such that a receiver of the wireless device is expected to operate in a low-power state during a scheduled low-power period of time and the receiver is expected to operate in an active-power state during a scheduled active-power period of time. The wireless device schedules a measurement of a positioning signal using the receiver. The measurement is scheduled to occur during a scheduled measurement period of time. The scheduled measurement period of time at least partially overlaps with at least one of the scheduled low-power period of time or the scheduled active-power period of time. The wireless device operates the wireless device in the DRX mode of operation after scheduling the measurement and before a start of the scheduled measurement period of time.

### BACKGROUND

Wireless communications systems are widely deployed to provide various types of communication content such as voice, multimedia data, packet data, messaging, broadcast, etc. A wireless device, such as a cellular telephone, includes a battery to provide power to the various components of the wireless device, such as a processor and a wireless receiver. To conserve battery power, wireless devices may operate in a “sleep mode.” While in the sleep mode, a wireless receiver of the wireless device enters an “off phase” for a period of time and periodically enters an “on phase” to receive particular messages, such as paging messages, from a base station of a wireless network. An example of a technique that implements a sleep mode is a discontinuous reception (DRX) functionality defined by the 3rd Generation Partnership Project (3GPP) for use in long term evolution (LTE) wireless communications systems. When the DRX functionality is implemented, the wireless device enters a DRX cycle by periodically cycling between an active-power state, during which paging messages from a base station may be received, and a low-power state, during which no signals are received by the wireless receiver. Shutting down certain components of the wireless receiver during the off phase saves power because, for example, a clock of the wireless receiver does not use battery power during the off phase of the DRX cycle.

Wireless communications systems also provide positioning techniques for determining a location of a mobile device. For example, Observed Time Difference Of Arrival (OTDOA) is a LTE positioning procedure defined by the 3GPP. In OTDOA, a wireless device receives positioning reference signals (PRS) from nearby base stations of a wireless network. The wireless device makes Reference Signal Time Difference (RSTD) measurements using time of arrival estimates of the received PRS. The UE reports back the RSTD measurements to a location server of the wireless network, where the location of the UE is determined. For the wireless device to make the RSTD measurements, the wireless device uses information about the PRS that the wireless device expects to receive, referred to as assistance data. The information included in the assistance data consists of a list of nearby base stations and associated PRS parameters for each of the nearby base stations, the PRS parameters including the transmission frequency band (channel), the periodicity, and the timing offset relative to some reference.

When a conventional wireless device performs a positioning technique, such as OTDOA, the conventional wireless device disables DRX functionality to ensure that no PRS are missed by the wireless receiver as a result of being in the low-power state when the PRS arrives at the device.

### SUMMARY

An example of a method of operating a wireless device includes determining, using a processor of the wireless device, to operate the wireless device in a discontinuous reception (DRX) mode of operation that includes a low-power portion and an active-power portion such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state; scheduling, using the processor of the wireless device, a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and operating the wireless device in the DRX mode of operation after scheduling the measurement and through at least the scheduled measurement period of time.

Implementations of such a method may include one or more of the following features. The scheduled low-power period of time may be a first scheduled low-power period of time. The method may include operating, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time. The method may include, in response to determining that a start of the scheduled measurement period of time is scheduled to occur before an early threshold time after a start of the first scheduled low-power period of time: maintaining the receiver in the active-power state at the start of the first scheduled low-power period of time; measuring the positioning signal using the receiver in the active-power state; and placing the receiver in the low-power state after the positioning signal is measured and before an end of the first scheduled low-power period of time. The method may include, in response to determining that a start of the scheduled measurement period of time is scheduled to occur after a late threshold time before an end of the first scheduled low-power period of time: placing the receiver in the low-power state at a start of the first scheduled low-power period of time; placing the receiver in the active-power state after the start of the first scheduled low-power period of time and before the start of the scheduled measurement period of time; measuring the positioning signal using the receiver in the active-power state; and maintaining the receiver in the active-power state until an end of a first scheduled active-power period of time that is scheduled to occur subsequent to the first scheduled low-power period of time. The method may include, in response to determining that the scheduled measurement period of time is scheduled to occur after an early threshold time after a start of the first scheduled low-power period of time and before a late threshold time before an end of the first scheduled low-power period of time: placing the receiver in the low-power state at the start of the first scheduled low-power period of time; placing the receiver in the active-power state after the start of the first scheduled low-power period of time and before the scheduled measurement period of time; measuring the positioning signal using the receiver in the active-power state; and placing the receiver in the low-power state after measuring the positioning signal and before the end of the first scheduled low-power period of time. The method may include, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time: maintaining the receiver in the active-power state at the start of the first scheduled low-power period of time; measuring the positioning signal using the receiver in the active-power state during a portion of the first scheduled active-power period of time and during the overlap period of time; and placing the receiver in the low-power state after the positioning signal is measured and before an end of the first scheduled low-power period of time.

Implementations of such a method may also include one or more of the following features. The method may include operating the receiver in the active-power state during the scheduled low-power period of time, and measuring the positioning signal using the receiver in the active-power state during the scheduled low-power period of time. The method may include correcting an error in a clock of the receiver after placing the receiver in the active-power state.

An example of a wireless device for receiving positioning signals includes a receiver configured to operate in a low-power state, operate in an active-power state, wherein the receiver will use more power in the active-power state than in the low-power state, and receive signals when operating in the active-power state. The wireless device also includes a processor coupled to the receiver, the processor configured to: determine to operate the wireless device in a discontinuous reception (DRX) mode of operation that includes a low-power portion and an active-power portion such that the receiver is expected to operate in the low-power state during a scheduled low-power period of time and the receiver is expected to operate in the active-power state during a scheduled active-power period of time; schedule a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and operate the wireless device in the DRX mode of operation after scheduling the measurement and through at least the scheduled measurement period of time.

Implementations of such a wireless device may include one or more of the following features. The scheduled low-power period of time may be a first scheduled low-power period of time. The processor may be configured to operate, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time. The processor may be configured to respond to determining that a start of the scheduled measurement period of time is scheduled to occur before an early threshold time after a start of the first scheduled low-power period of time by: maintaining the receiver in the active-power state at the start of the first scheduled low-power period of time; measuring the positioning signal using the receiver in the active-power state; and placing the receiver in the low-power state after the positioning signal is measured and before an end of the first scheduled low-power period of time. The processor may be configured to respond to determining that a start of the scheduled measurement period of time is scheduled to occur after a late threshold time before an end of the first scheduled low-power period of time by: placing the receiver in the low-power state at a start of the first scheduled low-power period of time; placing the receiver in the active-power state after the start of the first scheduled low-power period of time and before the start of the scheduled measurement period of time; measuring the positioning signal using the receiver in the active-power state; and maintaining the receiver in the active-power state until an end of a first scheduled active-power period of time that is scheduled to occur subsequent to the first scheduled low-power period of time. The processor may be configured to respond to determining that the scheduled measurement period of time is scheduled to occur after an early threshold time after a start of the first scheduled low-power period of time and before a late threshold time before an end of the first scheduled low-power period of time: placing the receiver in the low-power state at the start of the first scheduled low-power period of time; placing the receiver in the active-power state after the start of the first scheduled low-power period of time and before the scheduled measurement period of time; measuring the positioning signal using the receiver in the active-power state; and placing the receiver in the low-power state after measuring the positioning signal and before the end of the first scheduled low-power period of time. The processor may be configured to respond to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time by: maintaining the receiver in the active-power state at the start of the first scheduled low-power period of time; measuring the positioning signal using the receiver in the active-power state during a portion of the first scheduled active-power period of time and during the overlap period of time; and placing the receiver in the low-power state after the positioning signal is measured and before an end of the first scheduled low-power period of time.

Implementations of such a wireless device may also include one or more of the following features. The processor may be configured to operate the receiver in the active-power state during the scheduled low-power period of time, and measure the positioning signal using the receiver in the active-power state during the scheduled low-power period of time. The processor may be configured to correct an error in a clock of the receiver after placing the receiver in the active-power state.

An example of a wireless device for receiving positioning signals includes: means for determining to operate the wireless device in a discontinuous reception (DRX) mode of operation that includes a low-power portion and an active-power portion such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state; means for scheduling a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and means for operating the wireless device in the DRX mode of operation after scheduling the measurement and through at least the scheduled measurement period of time.

Implementations of such a wireless device may include one or more of the following features. The scheduled low-power period of time may be a first scheduled low-power period of time. The wireless device may include means for operating, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time. The means for operating the receiver may be further for, in response to determining that a start of the scheduled measurement period of time is scheduled to occur before an early threshold time after a start of the first scheduled low-power period of time: maintaining the receiver in the active-power state at the start of the first scheduled low-power period of time; measuring the positioning signal using the receiver in the active-power state; and placing the receiver in the low-power state after the positioning signal is measured and before an end of the first scheduled low-power period of time. The means for operating the receiver may be further for, in response to determining that a start of the scheduled measurement period of time is scheduled to occur after a late threshold time before an end of the first scheduled low-power period of time: placing the receiver in the low-power state at a start of the first scheduled low-power period of time; placing the receiver in the active-power state after the start of the first scheduled low-power period of time and before the start of the scheduled measurement period of time; measuring the positioning signal using the receiver in the active-power state; and maintaining the receiver in the active-power state until an end of a first scheduled active-power period of time that is scheduled to occur subsequent to the first scheduled low-power period of time. The means for operating the receiver may be further for, in response to determining that the scheduled measurement period of time is scheduled to occur after an early threshold time after a start of the first scheduled low-power period of time and before a late threshold time before an end of the first scheduled low-power period of time: placing the receiver in the low-power state at the start of the first scheduled low-power period of time; placing the receiver in the active-power state after the start of the first scheduled low-power period of time and before the scheduled measurement period of time; measuring the positioning signal using the receiver in the active-power state; and placing the receiver in the low-power state after measuring the positioning signal and before the end of the first scheduled low-power period of time. The means for operating the receiver may be further for, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time: maintaining the receiver in the active-power state at the start of the first scheduled low-power period of time; measuring the positioning signal using the receiver in the active-power state during a portion of the first scheduled active-power period of time and during the overlap period of time; and placing the receiver in the low-power state after the positioning signal is measured and before an end of the first scheduled low-power period of time. The wireless device may include means for operating the receiver in the active-power state during the scheduled low-power period of time, and means for measuring the positioning signal using the receiver in the active-power state during the scheduled low-power period of time.

An example non-transitory, processor-readable storage medium includes processor-readable instructions configured to cause a processor of a mobile device to: determine to operate the wireless device in a discontinuous reception (DRX) mode of operation that includes a low-power portion and an active-power portion such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state; schedule a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and operate the wireless device in the DRX mode of operation after scheduling the measurement and through at least the scheduled measurement period of time.

Implementations of such a non-transitory, processor-readable storage medium may include one or more of the following features. The scheduled low-power period of time may be a first scheduled low-power period of time. The non-transitory, processor-readable storage medium may include instructions configured to cause the processor to operate, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time. The non-transitory, processor-readable storage medium may include instructions configured to cause the processor to, in response to determining that a start of the scheduled measurement period of time is scheduled to occur before an early threshold time after a start of the first scheduled low-power period of time: maintain the receiver in the active-power state at the start of the first scheduled low-power period of time; measure the positioning signal using the receiver in the active-power state; and place the receiver in the low-power state after the positioning signal is measured and before an end of the first scheduled low-power period of time. The non-transitory, processor-readable storage medium may include instructions configured to cause the processor to, in response to determining that a start of the scheduled measurement period of time is scheduled to occur after a late threshold time before an end of the first scheduled low-power period of time: place the receiver in the low-power state at a start of the first scheduled low-power period of time; place the receiver in the active-power state after the start of the first scheduled low-power period of time and before the start of the scheduled measurement period of time; measure the positioning signal using the receiver in the active-power state; and maintain the receiver in the active-power state until an end of a first scheduled active-power period of time that is scheduled to occur subsequent to the first scheduled low-power period of time. The non-transitory, processor-readable storage medium may include instructions configured to cause the processor to, in response to determining that the scheduled measurement period of time is scheduled to occur after an early threshold time after a start of the first scheduled low-power period of time and before a late threshold time before an end of the first scheduled low-power period of time: place the receiver in the low-power state at the start of the first scheduled low-power period of time; place the receiver in the active-power state after the start of the first scheduled low-power period of time and before the scheduled measurement period of time; measure the positioning signal using the receiver in the active-power state; and place the receiver in the low-power state after measuring the positioning signal and before the end of the first scheduled low-power period of time. The non-transitory, processor-readable storage medium may include instructions configured to cause the processor to, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time: maintain the receiver in the active-power state at the start of the first scheduled low-power period of time; measure the positioning signal using the receiver in the active-power state during a portion of the first scheduled active-power period of time and during the overlap period of time; and place the receiver in the low-power state after the positioning signal is measured and before an end of the first scheduled low-power period of time. The non-transitory, processor-readable storage medium may include instructions configured to cause the processor to: operate the receiver in the active-power state during the scheduled low-power period of time; and measure the positioning signal using the receiver in the active-power state during the scheduled low-power period of time.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented to provide a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a block diagram of an example communications environment.

FIG. 2 is a block diagram of an example wireless device shown in FIG. 1.

FIG. 3 is an example of assistance data that may be received the wireless device of FIG. 2.

FIG. 4 is an example timing diagram for a scheduled DRX cycle and a positioning signal scheduled to arrive during an active-power phase of the scheduled DRX cycle.

FIG. 5 are example scheduled and adjusted DRX cycle timing diagrams for a positioning signal scheduled to be received during an early stage of a low-power phase of the scheduled DRX cycle.

FIG. 6 are example scheduled and adjusted DRX cycle timing diagrams for a positioning signal scheduled to be received during a late stage of a low-power phase of the scheduled DRX cycle.

FIG. 7 are example scheduled and adjusted DRX cycle timing diagrams for a positioning signal scheduled to be received during an intermediate stage of a low-power phase of the scheduled DRX cycle.

FIG. 8 are example scheduled and adjusted DRX cycle timing diagrams for a positioning signal scheduled to be received during an active-power phase of the scheduled DRX cycle and continues into a low-power phase of the scheduled DRX cycle.

FIG. 9 is a flow diagram of an example method of operating the wireless device of FIG. 2.

FIG. 10 is a flow diagram of an example method of operating the wireless device of FIG. 2 when a positioning signal is scheduled to arrive during an early stage of a low-power phase of a DRX cycle.

FIG. 11 is a flow diagram of an example method of operating the wireless device of FIG. 2 when a positioning signal is scheduled to arrive during a late stage of a low-power phase of a DRX cycle.

FIG. 12 is a flow diagram of an example method of operating the wireless device of FIG. 2 when a positioning signal is scheduled to arrive during an intermediate stage of a low-power phase of a DRX cycle.

FIG. 13 is a flow diagram of an example method of operating the wireless device of FIG. 2 when a positioning signal is scheduled to arrive during an active-power phase of a DRX cycle and continues into a low-power period of time.

FIG. 14 is a functional block diagram of an example wireless device shown in FIG. 1 and FIG. 2.

### DETAILED DESCRIPTION

Techniques are discussed herein for modifying a DRX cycle to accommodate the measurement of positioning signals for use in determining the location of a wireless device. For example, a processor of the wireless device may control the wireless device to operate in a DRX mode of operation even when the wireless device is implementing a positioning technique and expected to receive and measure positioning signals from one or more base stations. The processor may modify the DRX cycle by adjusting the time at which the wireless device enters a low-power phase of the DRX cycle and/or a time at which the wireless device enters an active-power phase of the DRX such that positioning signals are likely to be received while the wireless device is in an active-power state, e.g., to help prevent a DRX cycle associated with the DRX mode of operation from impacting the ability of the wireless device to measure the positioning signals. The processor uses the modified DRX cycle to control a wireless receiver of the wireless device while maintaining the wireless device in the DRX mode of operation such that, at the end of the modified DRX cycle, the wireless device continues with the scheduled DRX cycle (unless otherwise modified by the wireless device to accommodate the arrival of another positioning signal). The processor makes different modifications, or no modification at all, to the DRX cycle for each positioning signal based on a time that the positioning signal is expected to be received relative to the active-power phase and low-power phase of the DRX cycle. The processor of the wireless device may schedule measurements of the positioning signals based on information about the positioning signals received from assistance data received from a location server. The processor may correct for errors in a clock of the wireless receiver after the wireless device enters the active-power state, e.g., to help ensure accurate measurements of the time of arrival of positioning signals.

Items and/or techniques described herein may provide one or more of the following capabilities, as well as other capabilities not mentioned. Efficient operation of a wireless receiver may be maintained despite performing measurements of positioning signals. Power consumption during the performance of a positioning technique may be reduced and this may extend the battery life of a wireless device. Battery power may be conserved during the measurement of positioning signals as compared to conventional techniques that disable the DRX mode of operation while performing a positioning technique. Location services during emergency calls may be performed even when the battery power is very low. Accurate, power-efficient indoor positioning techniques may be implemented for narrowband Internet of Things (NB-IoT) devices, e.g., where global positioning systems (GPS) are not accurate and consume too much power. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

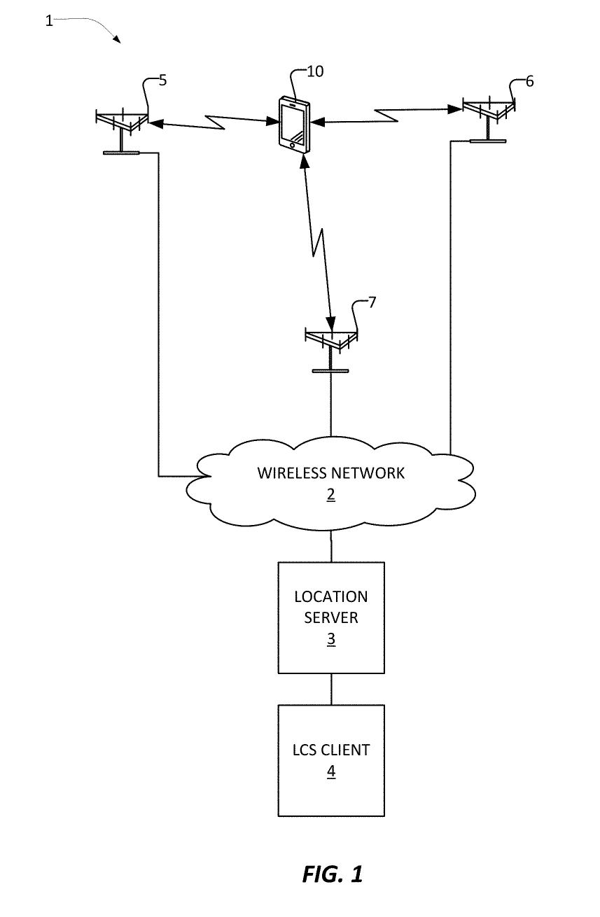

Referring to FIG. 1, an example communications environment 1 capable of performing one or more positioning techniques to determine a location of a wireless device 10 includes a wireless network 2, a location server 3, a location services (LCS) client 4, and three base stations 5-7. The location server 3, the LCS client 4, and the base stations 5-7 are considered a part of the wireless network 2. For the sake of clarity, however, the location server 3, the LCS client 4, and the base stations 5-7 are shown separate from the wireless network 2. The wireless network 2 used the base stations 5-7 to communicate with the wireless device 10 by wirelessly sending and receiving messages to and from the wireless device 10. Also, while multiple wireless devices may operate within the communications environment 1, only a single wireless device 10 is shown for the sake of simplicity and clarity.

The wireless network 2 may be a wireless wide area network (WWAN), wireless local area network (WLAN), or a wireless personal area network (WPAN). Examples of a WWAN include a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMax network or some other multiple access network.

A CDMA network may implement one or more radio access technologies (RATs) such as cdma2000, Wideband-CDMA (W-CDMA), etc. Cdma2000 includes IS-95, IS-2000, and IS-856 standards. A TDMA network may implement Global System for Mobile Communications (GSM), Digital Advanced Mobile Phone System (D-AMPS), or some other RAT. GSM, W-CDMA, and LTE are described in documents from 3GPP. Cdma2000 is described in publicly available documents from a consortium named “3rd Generation Partnership Project 2” (3GPP2). A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN. For example, base stations 5-7 and wireless network 2 may form part of, e.g., an evolved UMTS Terrestrial Radio Access Network (E-UTRAN), an LTE network, a W-CDMA UTRAN network, a GSM/EDGE Radio Access Network (GERAN), a 1×RTT network, an Evolution-Data Optimized (EvDO) network, a WiMax network or a WLAN.

The base stations 5-7 are communicatively coupled to other portions of the wireless network 2 using, for example, a physical connection, such as a wired or optical connection. In situations where the wireless network 2 is an LTE network, the other portions of the particular network may include, but are not limited to, a packet data network gateway, a mobility management entity (MME), a serving gateway, and additional base stations.

The location server 3 may be one of a variety of server types. For example, the location server 3 may be an Evolved Serving Mobile Location Centre (E-SMLC), a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or MMEs. The location server 3 stores assistance data for the wireless network 3, which may include information about the base stations 5-7 and information about positioning signals transmitted by the base stations 5-7.

The LCS client 4 is any entity that sends a request to the location server 3 for the location of a target, such as the wireless device 10. The LCS client 4 may be implemented using: a computer system that is part of the wireless network 2 (as shown in FIG. 1), a computer system that is external to the wireless network 2, or the wireless device 10. An example of the LCS client 4 being implemented by a computer system external to the wireless network 2 may be a computer system operated by an emergency services entity that is configured to request, e.g., by executing software instructions, the location of the wireless device 10 in response to receiving an emergency call (e.g., an E-911 call) from the mobile device 10. An example of the LCS client 4 being implemented by the wireless device 10 may include software executing on the wireless device 10 that requests the location of the wireless device 10.

When in the communications environment 1, the wireless device 10 receives a variety of wireless signals from the base stations 5-7. The wireless device 10 is said to “camp” to a particular base station when the base station is selected by the wireless device 10 as the primary base station (sometimes referred to as the serving base station or the serving cell) for communications with the wireless network 2. For example, the wireless device 10 may be camped to the base station 6. When the wireless device 10 is camped to the base station 6, the wireless device 10 receives paging messages from the base station 6 and sends information to the base station 6 for maintaining and managing the connection to the wireless network 2. The primary base station may change as the wireless device 10 moves throughout the communications environment 1. For example, as the wireless device 10 moves towards the base station 5, the wireless device 10 may handover the role of primary base station to the base station 5.

The primary base station sends and receives information related to performing a positioning technique to and from the wireless device 10. For example, the primary base station wirelessly transmits assistance data to the wireless device 10 for use in performing one or more positioning techniques. The assistance data originates from the location server 3 of the wireless network 2. The assistance data include information about the positioning signals that the wireless device 10 is expected to receive from the primary base stations 5-7. Additionally, after making measurements of the positioning signals, the wireless device 10 sends the measurement results to the primary base station for transmission back to the location server 3.

The assistance data received by the wireless device 10 from location server 3 includes at least an indication of the identity of each of the base stations for which information is provided, an indication of the frequency channel (corresponding to an RF band) that each base station will use to send a respective positioning signal, and an indication of the time at which the respective positioning signal is expected to be received by the wireless device 10. The indication of the time at which the positioning signal is expected to be received may include an indication of the location of the positioning signal within a frame received from a base station. The indication of the location of the positioning signal within a frame may be an indication of a periodicity of the positioning signal (e.g., measured in milliseconds or number of sub-frames), an indication of a sub-frame offset value of the positioning signal, and an indication of the duration of the positioning signal (e.g., measured in milliseconds or number of sub-frames). In the case of OTDOA, the positioning signals are PRS, as defined by the LTE standard. When performing OTDOA, the wireless device 10 makes time difference measurements between the arrival time of PRS received from different base stations and the measurement results are sent to the location server 3, where the location of the wireless device 10 is determined using the measurement results.

The wireless device 10 is configured to perform at least a portion of a positioning technique. For example, the wireless device 10 may perform time difference measurements, such as RSTD measurements, which are differences between the arrival times of positioning signals received from multiple base stations. When the positioning technique being performed by the wireless device 10 is OTDOA, measurement results from the measurements are sent to the location server 3 to determine the location of the wireless device 10. The location server 3 sends the determined location of the wireless device 10 to the LCS client 4 that initially requested the location of the wireless device 10.

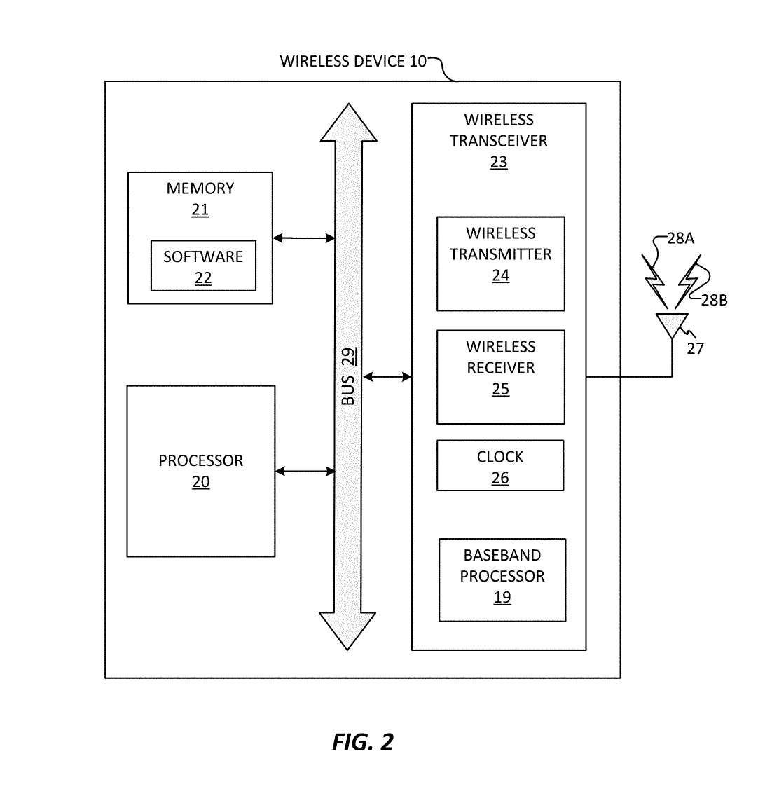

Referring to FIG. 2, with further reference to FIG. 1, an example of the wireless device 10 includes a processor 20, a memory 21 with software 22 stored thereon, and a wireless transceiver 23. The wireless device 10 is a computer system that may be a handheld mobile device, such as a mobile phone or smart phone. The wireless device 10 may also be some other user equipment (UE) such as a NB-IoT device, which may not necessarily be mobile. The processor 20 is an intelligent device, e.g., a central processing unit (CPU) such as those made or designed by Qualcomm®, ARM®, Intel® Corporation, or AMD®, a digital signal processor (DSP), a microcontroller, an application specific integrated circuit (ASIC), etc. The memory 21 is a non-transitory, processor-readable storage medium that stores instructions, such as software 22, that may be executed by processor 20 and includes random access memory (RAM), read-only memory (ROM) and non-volatile memory such as flash memory or solid state storage. The software 22 can be loaded onto the memory 21 by being downloaded via a network connection, uploaded from a disk, etc. Further, the software 22 may not be directly executable, e.g., requiring compiling before execution. The software 22 includes instructions configured to cause the processor 20 to perform functions described herein.

The various components of the UE 10 are communicatively coupled to one another via a bus 29, which is configured to transmit information from one component to another component. For example, the processor 20 is communicatively coupled to the wireless transceiver 23 and the memory 21 via the bus 29. The processor 20 is configured to control the operations of the wireless transceiver 23 by sending commands and information to the wireless transceiver 23 via the bus 29. The wireless transceiver 23 is configured to send information wirelessly received from a base station of the wireless network 2 to the processor 20 and/or the memory 21 via the bus 29.

The wireless transceiver 23 includes a wireless transmitter 24, a wireless receiver 25, a clock 26, and a baseband processor 19. The wireless transmitter 24 is configured to transmit, via antenna 27, wireless signals 28A that are intended to be received by one or more base stations of the wireless network 2. For example, the wireless transmitter 24 may send measurement results, such as RSTD results, intended for the location server 3 to a primary base station, such as base station 6. The wireless receiver 25 is configured to receive, via the antenna 27, wireless signals 28B, sent by one or more base stations of the wireless network 2. For example, the wireless signals 28B may include a positioning signal received from one or more of the base stations 5-7. The wireless receiver 25 is configured to receive the positioning signal and measure one or more properties of the positioning signal. For example, the wireless receiver 25 may determine the time of arrival of the positioning signal relative to the clock 26 of the wireless transceiver 23. Alternatively, or additionally, the wireless receiver 25 may determine the time difference of arrival of two different positioning signals from two different base stations using the clock 26. Furthermore, the wireless receiver 25 may be configured to receive the assistance data associated with the base stations 5-7 from the location server 3. While the wireless transceiver 23 is shown separate from the processor 20, the wireless transceiver 23 may include one or more processors for performing the actions described herein as being performed by the processor 20. Furthermore, while the clock 26 is shown as external to the wireless receiver 25 and the wireless transmitter 24, the clock 26 may be part of the wireless receiver 25 and/or the wireless transmitter 24. Even if the clock 26 is external to the wireless receiver 25, for the purposes of the present disclosure, the clock 26 is considered part of the wireless receiver 25.

The baseband processor 19 may control the wireless receiver 25 and the wireless transmitter 24 based on instructions received from the processor 20. When the wireless transceiver 23 operates in a low-power mode when the wireless device 10 is operating in a DRX mode of operation, the baseband processor 19 may also operate in a low-power mode. While the baseband processor 19 is shown as separate from the wireless receiver 25 and the wireless transmitter 24, the baseband processor 19 may be or be considered to be part of one or both of the wireless receiver 25 and the wireless transmitter 24. Furthermore, actions described herein as being performed by the processor 20 may be performed by the baseband processor 19 or performed by a combination of the baseband processor 19, the processor 20, and any other processor included in mobile device 10.

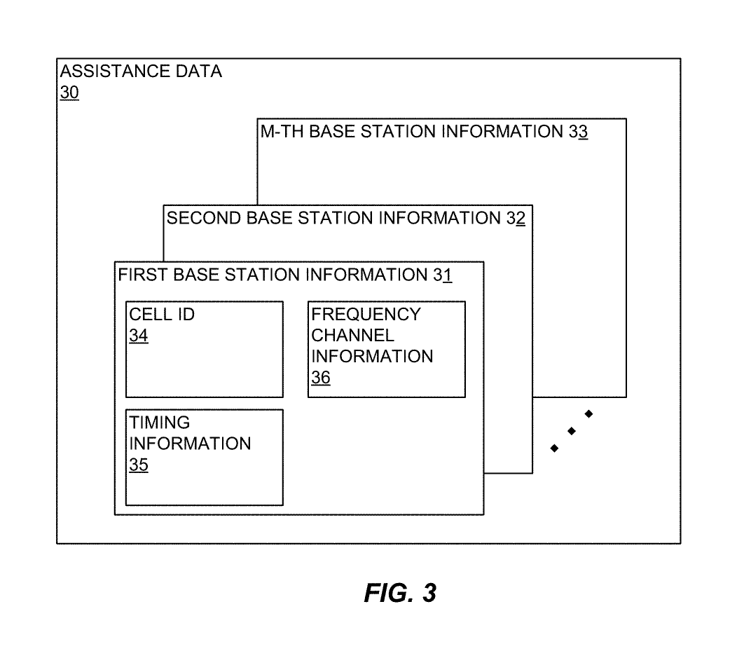

Referring to FIG. 3, with further reference to FIGS. 1-2, an example of the assistance data received by the wireless receiver 25 is the assistance data 30, which includes information for use by the wireless device 10 for performing one or more positioning techniques. The assistance data 30 is representative of the assistance data sent by the location server 3 of the wireless network 2. The assistance data 30 includes information about multiple base stations of the wireless network 2. For example, the assistance data 30 includes first base station information 31, second base station information 32, and m-th base station information 33, where m is the total number of base stations for which information is provided by the assistance data 30. Base station information is also provided for any other base station between the second base station and the m-th base station (not shown). For the sake of simplicity and clarity, FIG. 3 only illustrates details for the first base station information 31. The information associated with the other base stations may be the same type of information as the first base station information 31, or it may be different.

The first base station information 31 includes a cell identification (ID) 34, timing information 35 and frequency channel information 36, but additional information may be included. An example of a cell ID 34 is an identifier that the wireless device 10 and the wireless network 2 use to identify and/or address a particular base station. The timing information 35 includes an estimate of when the wireless device 10 is expected to receive a positioning signal. For example, the timing information 35 may include a periodicity, a timing offset and a duration of a positioning signal emitted by the base station. Alternatively or additionally, the timing information 35 may include an indication of a specific time that a particular positioning signal is expected to arrive at the wireless device 10. The frequency channel information 36 includes an indication of a frequency band on which the positioning signal will be transmitted by the base station. The timing information 35 and frequency channel information 36 may be used by the processor 20 of the wireless device 10 to control the times and frequency channels that the wireless receiver 25 searches for the positioning signal in order to perform a measurement of the positioning signal.

The second base station information 32 and the m-th base station information 33 may include information similar to the first base station information 31, but for respective signals from respective base stations.

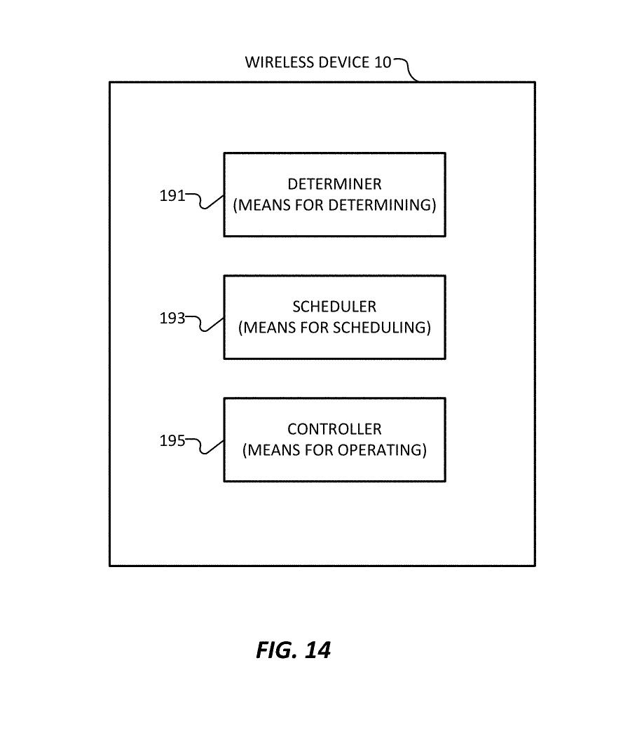

Referring to FIG. 14, with further reference to FIGS. 1-2, the mobile device 10 includes a determiner (means for determining) 191, a scheduler (means for scheduling) 193, and a controller (means for operating) 195. The determiner 191, the scheduler 193, and the controller 195 are functional modules implemented by at least the processor 20 and the software 22 stored in the memory 21. Thus, reference to any of the modules 191, 193, 195 performing or being configured to perform a function is shorthand for the processor 20 performing or being configured to perform the function in accordance with the software 22 (and/or firmware, and/or hardware of the processor 20). Similarly, reference to the processor 20 performing a determining, scheduling, or operation function, is equivalent to the measurement module 191, the region determination module 193, or the position determination module 195, respectively, performing the function.

Returning to FIG. 2, with further reference to FIGS. 1, 3 and 14, the processor 20 is configured to control the operation of the wireless transceiver 23, including the wireless transmitter 24 and the wireless receiver 25. For example, the controller 195 may control the operation of the wireless transceiver 23. For example, the processor 20 may control the wireless receiver 25 to periodically change between operating in a low-power state or an active-power state when the wireless device 10 is operating in the DRX mode. Operating in the DRX mode may include controlling the wireless receiver 25 to cycle between an active-power phase of the DRX cycle, when the wireless receiver 25 operates in an active-power state, and a low-power phase of the DRX cycle, when the wireless receiver 25 operates in a low-power state that consumes less power than operating in the active-power state. In this context, a “low-power phase” means a period of time during which the wireless receiver 25 operates in a low-power state, and an “active-power phase” means a period of time during which the wireless receiver 25 operates in an active-power state.

The wireless receiver 25 is configured to, when operating in an active-power state, receive signals from one or more base stations. For example, the wireless receiver 25 may receive positioning signals (e.g., PRS) by searching for the positioning signals at a particular time and on a particular frequency channel based on the timing information 35 and the frequency channel information 36, respectively. Additionally, during the active-power phase, the wireless receiver may also receive paging messages or other status information for use in managing the connection between the wireless device 10 and the wireless network 2.

The processor 20 is configured to determine to operate the wireless device 10 in a DRX mode of operation such that the wireless receiver 25 is expected to operate in the low-power state during a scheduled low-power period of time and the receiver is expected to operate in the active-power state during a scheduled active-power period of time. For example, the determiner 191 can make a determination to operate the wireless device 10 as described herein. The processor 20 may determine to operate the wireless device 10 in a DRX mode in response to a trigger event. For example, the processor 20 may monitor the signals sent and received by the wireless transceiver 23 for inactivity. If particular types of data are not sent or received via the transceiver 23 for some threshold period of time, the processor 20 may determine to operate the wireless device 10 in the DRX mode of operation. The particular types of data that are monitored may include voice data, multimedia data and other application-level data, and may not include status data and data sent and/or received to manage the connection of the mobile device 10 to the wireless network 2. Alternatively, the processor 20 may determine to operate the wireless device 10 in a DRX mode in response to receiving a message from the wireless network 2 to enter the DRX mode of operation.

The processor 20 may be configured to respond to a determination to operate the wireless device 10 in the DRX mode of operation by sending commands to the wireless receiver 25 to implement a particular phase of the DRX cycle. The DRX cycle includes a low-power period of time and an active-power period of time. The low-power period of time may be longer than the active-period of time. During the low-power period of time, the clock 26 may be turned off to reduce power consumption by the wireless receiver 25. The processor 20 includes a clock (not shown) for determining when the wireless device 10 should be operating in the low-power state or the active-power state. The processor 20 is configured to send, via the bus 29, a command to the wireless receiver 25 to enter the low-power state at the beginning of the low-power phase of the DRX cycle. The processor 20 is also configured to send, via the bus 29, a command to the wireless receiver 25 to enter the active-power state at the beginning of the active-power phase of the DRX cycle.

The wireless receiver 25 is configured to receive the commands from the processor 20 and take appropriate action. For example, the wireless receiver 25 is configured to respond to receiving a command to enter the low-power state by turning off the clock 26 to reduce the amount of power consumed by the wireless receiver 25. The wireless receiver 25 is also configured to respond to receiving the command to enter the active-power state by turning on the clock 26 to prepare to measure incoming signals received by the antenna 27.

The processor 20 may be configured to schedule a measurement of a positioning signal using the wireless receiver 25. For example, the scheduler 193 may schedule the measurement of the positioning signal. The measurement is scheduled to occur during a scheduled measurement period of time, wherein the scheduled measurement period of time at least partially overlaps with at least one of the scheduled low-power period of time or the scheduled active-power period of time. The processor 20 may schedule the measurement before or after determining to operate the wireless device 10 in the DRX mode of operation. The processor 20 may be configured to schedule the measurement based on the assistance data 30 received from the location server 3. For example, the timing information 35 may be used to determine when the positioning signal is scheduled to arrive at the wireless device 10. The processor 20 may schedule the measurement period of time to be larger than the expected duration of the positioning signal to accommodate variation in the arrival time of the positioning signal.

The processor 20 may further be configured to operate the wireless device 10 in the DRX mode of operation after scheduling the measurement and through at least the scheduled measurement period of time. For example, the scheduler controller 195 may control the operation of the wireless device as discussed herein. By operating the wireless device 10 in the DRX mode of operation after scheduling a measurement period of time for measuring a positioning signal, the wireless device 10 may reduce the amount of power consumed by the wireless receiver 25 while performing the positioning technique. The wireless device 10 stays in the DRX mode after scheduling the measurement period of time and through the measurement period of time. The processor 20 may operate the wireless device 10 until it determines that the DRX mode should be exited. For example, if a paging message indicates that an incoming call or multimedia data will be received, the processor 20 may exit the DRX mode. However, the processor 20 will not make a determination to exit the DRX mode in response to incoming positioning signals. Instead, as discussed in the present disclosure, when the processor 20 determines that positioning signals are expected to be received, the processor 20 stays in the DRX mode and may alter the times at which the wireless receiver 25 is in active-power state or a low-power state.

In order to operate the device 10 in the DRX mode of operation while performing the positioning technique, the processor 20 may modify the DRX cycle to ensure that the wireless receiver 25 is in an active-power state during the scheduled measurement period of time. There may be situations, however, where the DRX cycle is not modified by the processor 20.

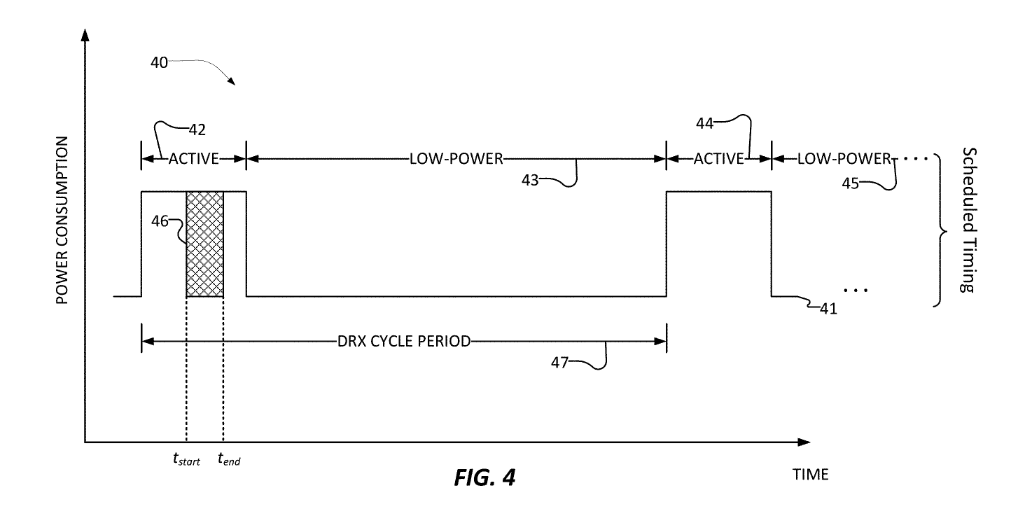

Referring to FIG. 4, a timing diagram 40 is shown for a situation where a scheduled measurement period of time 46 occurs during a first active-power period of time 42 of a DRX cycle. The timing diagram 40, which is not drawn to scale, includes a line 41 representing the power consumption (the y-axis) by the wireless receiver 25 as a function of time (the x-axis). The DRX cycle has a DRX cycle period 47, which is a duration of time that a single cycle of the DRX cycle takes to complete. The DRX cycle period 47 may be selected by the wireless device 10 to be any suitable time duration. By way of example and not limitation, the DRX cycle period 47 may be 20 milliseconds, 80 milliseconds, 320 milliseconds, 640 milliseconds, 1.2 seconds or 2.5 seconds. During a single DRX cycle there is an active-power period of time (where the line 41 is at a high level) and a low-power period of time (where the line 41 is at a low level). For example, a first DRX cycle includes the first active-power period of time 42, which is followed by a first low-power period of time 43. After the first DRX cycle, a second DRX cycle beings with a second active-power period of time, followed by a second low-power period of time 45, and the cycle repeats until the processor 20 takes the wireless device 10 out of the DRX mode of operation. Each active-power period of time may be a shorter duration than each low-power period of time. By way of example and not limitation, the first active-power period of time 42 may be on the order of a few milliseconds, 20 milliseconds, or 50 milliseconds. The first low-power period of time 43 has a duration that is the difference between the DRX cycle period 47 and the duration of the first active-power period of time 42.

In the timing diagram 40 the scheduled measurement period of time 46 occurs during the first active-power period of time 42. The scheduled measurement period of time 46 begins at a start time, tₛₜₐᵣₜ, and ends at an end time, t_{end}, both of which are within the first active-power period of time 42. The wireless receiver 25 is capable of measuring the expected positioning signal because the entirety of the scheduled measurement period of time 46 occurs while the wireless receiver 25 is in the active-power state. Thus, the processor 20 does not modify the DRX cycle.

While the ordinal numbers “first” and “second” are used to describe the active-power periods of time and the low-power periods of time, these terms are just for the purposes of distinguishing the illustrated periods of time. The “first active-period of time” is not necessarily the very first active-period of time that occurs after the wireless device 10 enters the DRX mode of operation. Instead, the first active-period of time may be in the middle of the time frame in which the wireless device 10 is operating in the DRX mode of operation.

There may be situations where the scheduled measurement period of time overlaps with a low-power period of time of a DRX cycle. The processor 20 is configured to modify the DRX cycle so that the wireless receiver 25 is in the active-power state during the scheduled measurement period of time. Even when the DRX cycle is modified, the wireless device 10 continues to operate in the DRX mode of operation. For example, the scheduled low-power period of time may be a first scheduled low-power period of time and the processor 20 may be configured to operate, in response to the scheduled measurement period of time overlapping the first scheduled low-power period of time for an overlap period of time, the receiver 25 in the active-power state during the overlap period of time without changing a scheduled timing of a second scheduled low-power period of time that is scheduled to occur subsequent to the first scheduled low-power period of time. The specific ways in which the DRX cycle is modified may depend on when the scheduled measurement period of time begins and ends relative to the DRX cycle. Examples of different ways that the DRX cycle can be modified are discussed below.

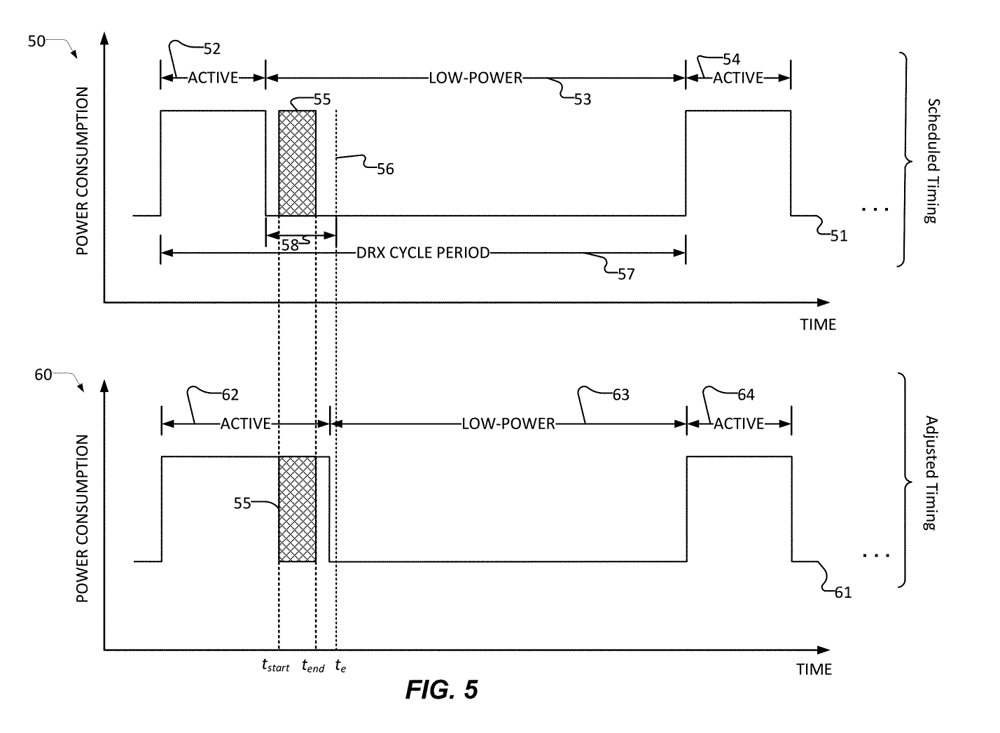

Referring to FIG. 5, a scheduled timing diagram 50 and an adjusted timing diagram 60 are shown for a situation where a scheduled measurement period of time 55 occurs during an early stage 58 of a first scheduled low-power period of time 53 of a scheduled DRX cycle. The scheduled timing diagram 50, which is not drawn to scale, includes a line 51 representing the scheduled power consumption (the y-axis) by the wireless receiver 25 as a function of time (the x-axis). The DRX cycle has a DRX cycle period 57, which is the amount of time a single cycle of the DRX cycle is scheduled to take to complete. The scheduled DRX cycle includes the first scheduled active-power period of time 52, which is followed by the first scheduled low-power period of time 53. The scheduled DRX cycle then repeats with a second scheduled active-power period of time 54, and the cycle repeats until the processor 20 takes the wireless device 10 out of the DRX mode of operation. The overlap period of time in this situation is the entire scheduled measurement period of time 55, which occurs entirely during the low-power period of time 53.

The early stage 58 of the first scheduled low-power period of time 53 is defined by an end of the active period of time 52 and an early threshold time 56, tₑ. If the scheduled measurement period of time 55 has a start time, tₛₜₐᵣₜ, that occurs during the first scheduled low-power period of time 53 before the early threshold time 56, tₑ, then the scheduled measurement period of time 55 is said to occur during the early stage 58 of the first scheduled low-power period of time 53. Example values of the early threshold time 56, tₑ, relative to the start of the low-power period of time 53 include: 3 milliseconds, 5 milliseconds, 10 milliseconds, or 20 milliseconds.

The processor 20 is configured to respond to determining that a start of the scheduled measurement period of time 55 is scheduled to occur before the early threshold time 56 after a start of the first scheduled low-power period of time 53 by: maintaining the wireless receiver 25 in the active-power state at the start of the first scheduled low-power period of time 53; measuring the positioning signal using the wireless receiver 25 in the active-power state; and placing the receiver in the low-power state after the positioning signal is measured and before an end of the first scheduled low-power period of time. The adjusted timing diagram 60 includes a line 61 representing a modified power consumption by the wireless receiver 25 based on a modified DRX cycle. By maintaining the wireless receiver 25 in the active-power state, the first active-power period of time 62 lasts longer than the first scheduled active-power period of time 52. The processor 20 determines the end of the first active-power period of time 62 based on an estimate of when the positioning signal is scheduled to be completely received. As shown in FIG. 5, the first active-power period of time 62 may end some time after the scheduled measurement period of time 55 ends in order to accommodate the possibility that the positioning signal arrives at the wireless device 10 at a time different than the scheduled measurement period of time 55. While the adjusted timing diagram 60 shows the scheduled measurement period of time 55 ending prior to the early threshold time 56, tₑ, this is not a limitation. In some examples, the scheduled measurement period of time 55 may end after the early threshold time 56, tₑ, and, therefore, the first active-power period of time 62 may end after the early threshold time 56, tₑ.

By modifying the first active-power period of time 62 to end at a later time than the end of the first scheduled active-power period of time 52, the first low-power period of time 63 begins at a later time than the scheduled low-power period of time 53. After a time when the first low-power period of time 63 begins, the processor 20 resumes the scheduled DRX cycle and controls the wireless receiver 25 to enter a second active-power period of time 64 at the same time as the second scheduled active-power period of time 54.

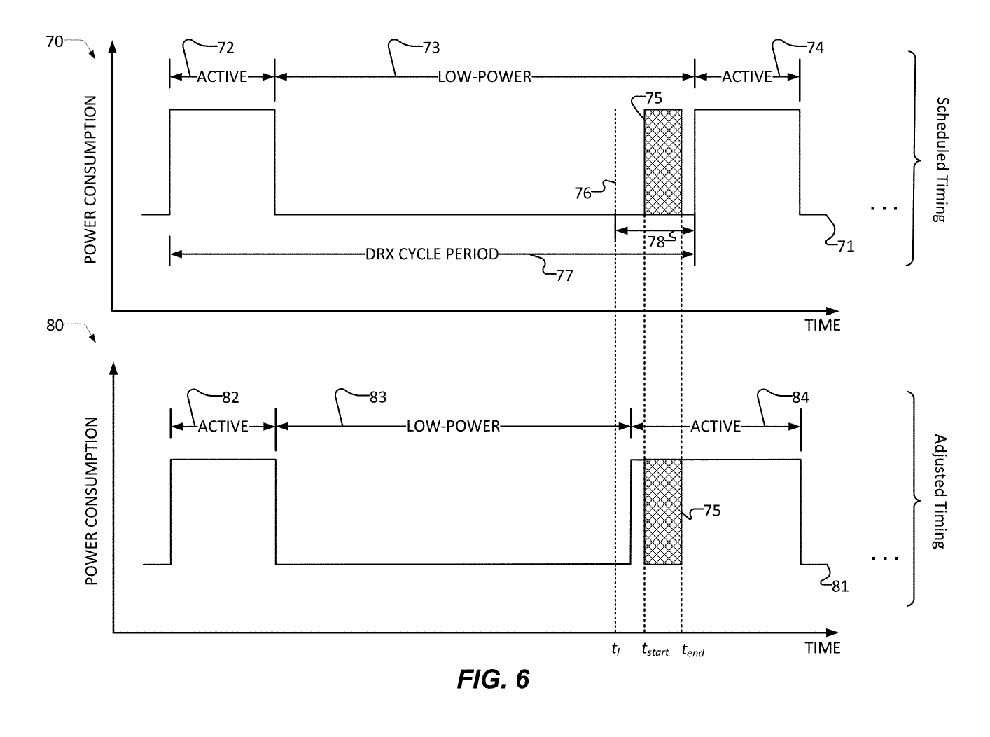

Referring to FIG. 6, a scheduled timing diagram 70 and an adjusted timing diagram 80 are shown for a situation where a scheduled measurement period of time 75 occurs during a late stage 78 of a first scheduled low-power period of time 73 of a scheduled DRX cycle. The scheduled timing diagram 70, which is not drawn to scale, includes a line 71 representing the scheduled power consumption (the y-axis) by the wireless receiver 25 as a function of time (the x-axis). The DRX cycle has a DRX cycle period 77, which is the amount of time a single cycle of the DRX cycle is scheduled to take to complete. The scheduled DRX cycle includes a first scheduled active-power period of time 72, which is followed by the first scheduled low-power period of time 73. The scheduled DRX cycle then repeats with a second scheduled active-power period of time 74, and the cycle repeats until the processor 20 takes the wireless device 10 out of the DRX mode of operation. The overlap period of time in this situation is the entire scheduled measurement period of time 75, which occurs entirely during the first scheduled low-power period of time 73.

The late stage 78 of the first scheduled low-power period of time 73 is defined by a late threshold time 76, tₗ and a beginning of the active period of time 74. If the scheduled measurement period of time 75 has a start time, tₛₜₐᵣₜ, that occurs during the first scheduled low-power period of time 53 after the late threshold time 76, t₁, then the scheduled measurement period of time 75 is said to occur during the late stage 78 of the first scheduled low-power period of time 73. Example values of the late threshold time 76, t₁, relative to the end of the first scheduled low-power period of time 73 include: 3 milliseconds, 5 milliseconds, 10 milliseconds, or 20 milliseconds.

The processor 20 is configured to respond to determining that a start of the scheduled measurement period of time 75 is scheduled to occur after the late threshold time 76 before an end of the first scheduled low-power period of time 73 by: placing the wireless receiver 25 in the low-power state at a start of the first scheduled low-power period of time 73; placing the receiver 25 in the active-power state after the start of the first scheduled low-power period of time 73 and before the start of the scheduled measurement period of time 75; measuring the positioning signal using the wireless receiver 25 in the active-power state; and maintaining the wireless receiver 25 in the active-power state until an end of a second scheduled active-power period of time 74 that is scheduled to occur subsequent to the first scheduled low-power period of time 73. The adjusted timing diagram 80 includes a line 81 representing a modified power consumption by the wireless receiver 25 based on a modified DRX cycle. By placing the wireless receiver 25 in the active-power state after the start of the first scheduled low-power period of time 73 and before the start of the scheduled measurement period of time 75, the second active-power period of time 84 lasts longer than the second scheduled active-power period of time 74. The processor 20 determines the beginning of the second active-power period of time 84 based on an estimate of when the positioning signal is scheduled to start being received. As shown in FIG. 6, the second active-power period of time 84 may begin some time before the scheduled measurement period of time 75 begins in order to accommodate the possibility that the positioning signal arrives at the wireless device 10 at a time different than the scheduled measurement period of time 75. While the adjusted timing diagram 80 shows the scheduled measurement period of time 75 ending prior to a start of the second scheduled active-power period of time 74, this is not a limitation. In some examples, the scheduled measurement period of time 75 may end after the start of the second scheduled active-power period of time 74.

By modifying the second active-power period of time 84 to start at an earlier time than the second scheduled active-power period of time 74, the first low-power period of time 83 ends at an earlier time than the first low-power period of time 73. After the point in time when the second active-power period of time 84 ends, the processor 20 resumes the scheduled DRX cycle and controls the wireless receiver 25 to enter a subsequent low-power period of time at the same time as was originally scheduled.

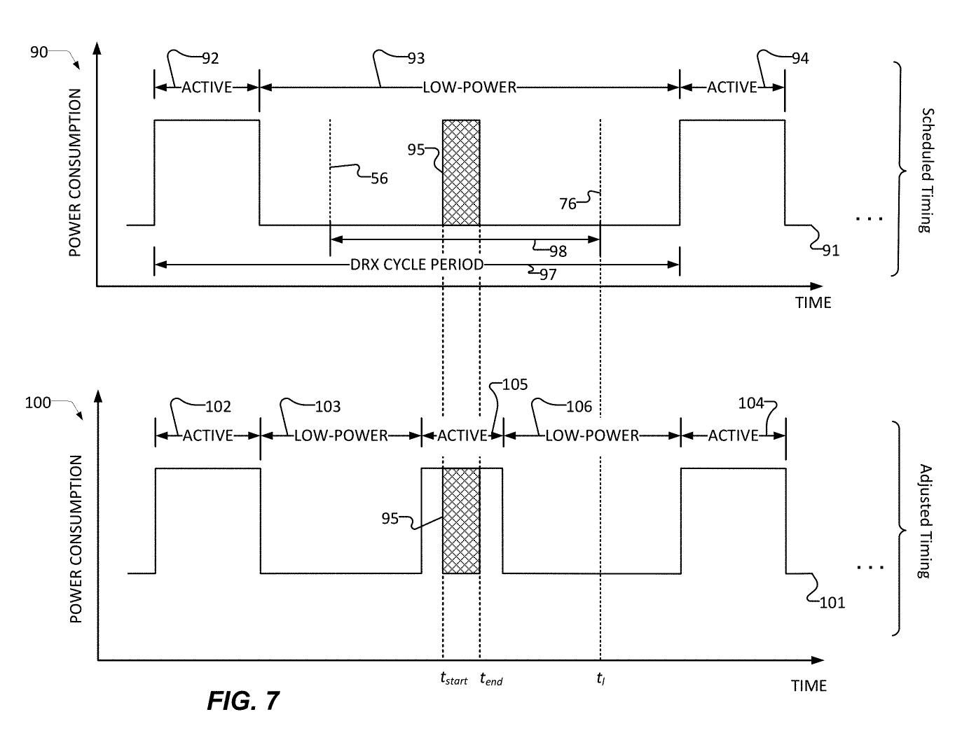

Referring to FIG. 7, a scheduled timing diagram 90 and an adjusted timing diagram 100 are shown for a situation where a scheduled measurement period of time 95 occurs during an intermediate stage 98 of a first scheduled low-power period of time 93 of a scheduled DRX cycle. The scheduled timing diagram 90, which is not drawn to scale, includes a line 91 representing the scheduled power consumption (the y-axis) by the wireless receiver 25 as a function of time (the x-axis). The DRX cycle has a DRX cycle period 97, which is the amount of time a single cycle of the DRX cycle is scheduled to take to complete. The scheduled DRX cycle includes the first scheduled active-power period of time 92, which is followed by a first scheduled low-power period of time 93. The scheduled DRX cycle then repeats with a second scheduled active-power period of time 94, and the cycle repeats until the processor 20 takes the wireless device 10 out of the DRX mode of operation. The overlap period of time in this situation is the entire scheduled measurement period of time 95, which occurs entirely during the first scheduled low-power period of time 93.

The intermediate stage 98 of the first scheduled low-power period of time 93 is defined by the early threshold time 56, tₑ, and the late threshold time 76, tₗ. If the scheduled measurement period of time 95 has a start time, tₛₜₐᵣₜ, that occurs during the first scheduled low-power period of time 93 after the early threshold time 56, tₑ, and before the late threshold time 76, tₗ, then the scheduled measurement period of time 95 is said to occur during the intermediate stage 98 of the first scheduled low-power period of time 93.

The processor 20 is configured to respond to determining that the scheduled measurement period of time 95 is scheduled to occur after an early threshold time 56 after a start of the first scheduled low-power period of time 93 and before a late threshold time 76 before an end of the first scheduled low-power period of time 93 by: placing the wireless receiver 25 in the low-power state at the start of the first scheduled low-power period of time 93; placing the wireless receiver 25 in the active-power state after the start of the first scheduled low-power period of time 93 and before the scheduled measurement period of time 95; measuring the positioning signal using the wireless receiver 25 in the active-power state; and placing the wireless receiver 25 in the low-power state after measuring the positioning signal and before the end of the first scheduled low-power period of time 93.

The adjusted timing diagram 100 includes a line 101 representing a modified power consumption by the wireless receiver 25 based on a modified DRX cycle. By placing the wireless receiver 25 in the active-power state after the start of the first scheduled low-power period of time 93 and before the start of the scheduled measurement period of time 95 and placing the wireless receiver 25 in the low-power state after measuring the positioning signal, the first low-power period of time 103 ends earlier than the first scheduled low-power period of time 93, an additional active-power period of time 105 is created, and an additional low-power period of time 106 is created. The second active-power period of time 104 begins at the same time as the second scheduled active-power period of time 94. The processor 20 determines the beginning and end of the additional active-power period of time 105 based on an estimate of when the positioning signal is scheduled to start being received and when the measurement of the positioning signal is scheduled to be complete. As shown in FIG. 7, the additional active-power period of time 105 may begin some time before the scheduled measurement period of time 95 begins and may end some time after the scheduled measurement period of time 95 ends in order to accommodate the possibility that the positioning signal arrives at the wireless device 10 at a time different than the scheduled measurement period of time 95. The sum of the first low-power period of time 103, the additional active-power period of time 105 and the additional low-power period of time 106 in the adjusted timing diagram 100 is equal to the scheduled low-power period of time 93 of the scheduled timing diagram 90.

By modifying the first low-power period of time 103 to end at an earlier time, the first active-power period of time 102 remains unmodified and ends at the same time as the first scheduled active-power period of time 92. By adding the additional active-power period of time 105 and the additional low-power period of time 106, the second active-power period of time 104 remains unmodified and begins at the same time as the second scheduled active-power period of time 94. After the point in time when the second active-power period of time 104 ends, the processor 20 resumes the scheduled DRX cycle and controls the wireless receiver 25 to enter a subsequent low-power period of time at the same time as was originally scheduled.

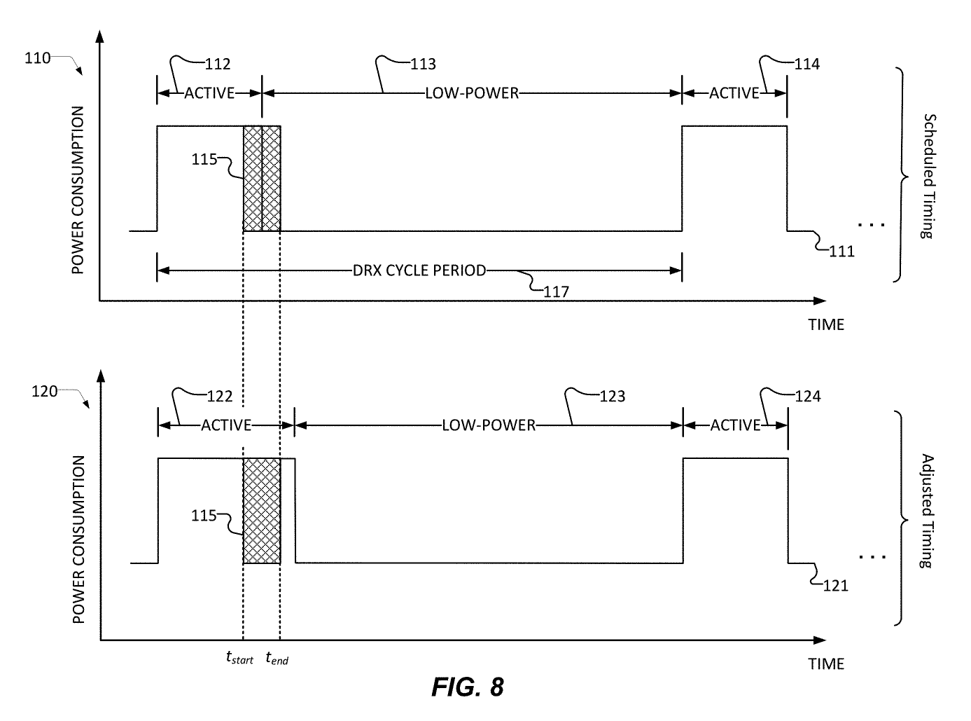

Referring to FIG. 8, a scheduled timing diagram 110 and an adjusted timing diagram 120 are shown for a situation where a scheduled measurement period of time 115 occurs during a first scheduled active-power period of time 112 of a scheduled DRX cycle and continues into a first scheduled low-power period of time 113 of the scheduled DRX cycle. The scheduled timing diagram 110, which is not drawn to scale, includes a line 111 representing the scheduled power consumption (the y-axis) by the wireless receiver 25 as a function of time (the x-axis). The DRX cycle has a DRX cycle period 117, which is the amount of time a single cycle of the DRX cycle is scheduled to take to complete. The scheduled DRX cycle includes the first scheduled active-power period of time 112, which is followed by the first scheduled low-power period of time 113. The scheduled DRX cycle then repeats with a second scheduled active-power period of time 114, and the cycle repeats until the processor 20 takes the wireless device 10 out of the DRX mode of operation. The overlap period of time in this situation is a portion of the scheduled measurement period of time 115 that occurs during the first scheduled low-power period of time 113.

The processor 20 is configured to respond to determining that a start of the scheduled measurement period of time 115 is scheduled to occur during a first scheduled active-power period of time 112 before a start of the first scheduled low-power period of time 113 and that an end of the scheduled measurement period of time 115 is scheduled to occur after the start of the first scheduled low-power period of time 113 by: maintaining the wireless receiver 25 in the active-power state at the start of the first scheduled low-power period of time 113; measuring the positioning signal using the wireless receiver 25 in the active-power state during a portion of the first active-power period of time 112 and during the overlap period of time; and placing the wireless receiver 25 in the low-power state after the positioning signal is measured and before an end of the first scheduled low-power period of time 113.

The adjusted timing diagram 120 includes a line 121 representing a modified power consumption by the wireless receiver 25 based on a modified DRX cycle. By maintaining the wireless receiver 25 in the active-power state, the first active-power period of time 122 lasts longer than the first scheduled active-power period of time 112. The processor 20 determines the end of the first active-power period of time 122 based on an estimate of when the positioning signal is scheduled to be completely received. As shown in FIG. 8, the first active-power period of time 122 may end some time after the scheduled measurement period of time 115 ends in order to accommodate the possibility that the positioning signal arrives at the wireless device 10 at a time different than the scheduled measurement period of time 115.

By modifying the first active-power period of time 122 to end at a later than the first scheduled active-power period of time 112, the first low-power period of time 123 begins later than the first scheduled low-power period of time 113. After the point in time when the first low-power period of time 123 begins, the processor 20 resumes the scheduled DRX cycle and controls the wireless receiver 25 to enter a second active-power period of time 124 at the same time as the second scheduled active-power period of time 114.

As discussed in the forgoing examples, the processor 20 may be configured to operate the wireless receiver 25 in the active-power state during a scheduled low-power period of time. The processor 20 may further be configured to measure a positioning signal using the wireless receiver 25 in the active-power state during the scheduled low-power period of time.

The processor 20 may be further configured to correct an error in the clock 26 of the wireless receiver 25. For example, correcting errors in the clock 26 may be done when the wireless receiver 25 is placed in the active-power state after being in the low-power state. Correcting for clock errors may result in more accurate determinations of the location of the wireless device because the location accuracy of a positioning technique depends on the accuracy of the measurement of the timing of the positioning signals, which itself depends of the clock 26 being accurate. Thus, after controlling the wireless receiver 25 to enter the active power state, the processor 20 may correct the error in the clock 26 according to the clock-error correction techniques described in U.S. Pat. No. 9,461,684, entitled “Fast system recovery in multi-radio-access-technology devices,” U.S. Pat. No. 6,735,454, entitled “Method and apparatus for activating a high frequency clock following a sleep mode within a mobile station operating in a slotted paging mode,” and U.S. Pat. No. 6,453,181, entitled “Method and apparatus for compensating for frequency drift in a low frequency sleep clock within a mobile station operating in a slotted paging mode,” each of which is incorporated herein by reference in their entirety.

The error in the clock 26 may be a timing error or a frequency error. The source of the error may be the drifting of the time and/or frequency of the clock 26 that occurs while it is off (e.g., while the wireless receiver 25 is in the low-power state). Using the aforementioned clock-error correction techniques, the clock errors can be extrapolated based on the amount of time the clock 26 was off (e.g., the duration of the low-power phase of the DRX cycle). For example, timing errors can be determined by characterizing the timing error when the clock 26 is on and extrapolating the timing error for periods of time when the clock 26 is off based on the previous characterization of the timing errors. In response to determining the timing error, the time of the clock 26 is corrected based on the timing error. Also using the aforementioned clock-error correction techniques, the frequency error of the clock 26 can be corrected. For example, the processor 20 may store a current frequency error for the clock 26 at all times (e.g., during the active-power state and the low-power state). The stored current frequency error may be referred to as the Recent Good System (RGS), which also stores a reference temperature for when the current frequency error was determined. The RGS may be stored in the memory 21 and managed by a software component in the memory 21 known as the Temperature Control Oscillator (TCXO) Manager (TCXOMGR). The wireless receiver 25 periodically reports the current frequency error and the current temperate to the TCXOMGR. The frequency error experienced by clocks using crystal oscillators is characterized by the equation:

f(t)=c₃(t−t₀)³+c₂(t−t₀)²+c₁(t−t₀)+c₀,

where c₃, c₂, c₁ and c₀ are coefficients determined from a previous device calibration, t₀ is the reference temperature of the clock 26 from the Recent Good System, and t is the current temperature of the clock 26. If there is a temperature variation between a current time and the reference temperature stored in the RGS, the TCXOMGR extrapolates the frequency error using the above equation. In the example of a DRX cycle, the temperature measurement made when the clock 26 was last on in an active-power phase (e.g., the RGS temperature) is compared to the temperature of the clock 26 after waking up from the low-power phase. If there is a difference between the RGS temperature and the temperature upon waking up, then the frequency error is corrected by the processor 20.

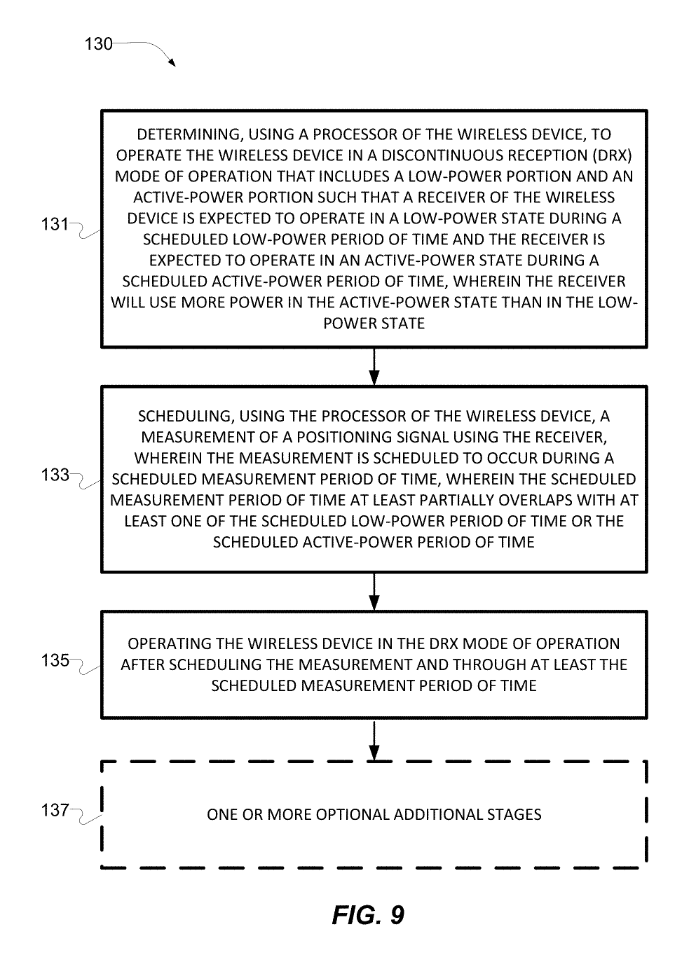

Referring to FIG. 9, with further reference to FIGS. 1-8, a method 130 of operating a wireless device, such as the wireless device 10, includes the stages shown. The method 130 is, however, an example only and not limiting. The method 130 can be altered, e.g., by having stages added, removed, rearranged, combined, performed concurrently, and/or having single stages split into multiple stages.

At stage 131, the method 130 includes determining, using a processor of the wireless device, to operate the wireless device in a DRX mode of operation such that a receiver of the wireless device is expected to operate in a low-power state during a scheduled low-power period of time and the receiver is expected to operate in an active-power state during a scheduled active-power period of time. The receiver will use more power in the active-power state than in the low-power state. For example, determining to operate the wireless device in a DRX mode of operation may be performed by the processor 20 of the wireless device 10 in response to some trigger event. For example, the processor 20 may monitor the wireless transceiver 23 for inactivity. If the wireless transceiver 23 is inactive for longer than a threshold amount of time, then the processor 20 may determine to enter the DRX mode of operation. Alternatively, the processor 20 may determine to operate the wireless device 10 in a DRX mode in response to receiving a message from the wireless network 2 to enter the DRX mode of operation.

At stage 133, the method 130 includes scheduling, using the processor of the wireless device, a measurement of a positioning signal using the receiver. The measurement is scheduled to occur during a scheduled measurement period of time. The scheduled measurement period of time at least partially overlaps with at least one of the scheduled low-power period of time or the scheduled active-power period of time. For example, scheduling the measurement of the positioning signal may be performing by the processor 20 using the assistance data 30 received from the location server 3. Specifically, the timing information 35 may be used to determine when the scheduled measurement period of time is relative to the active-power periods of time and the low-power periods of time of the DRX cycle.

At stage 135, the method 130 includes operating the wireless device in the DRX mode of operation after scheduling the measurement and through at least the scheduled measurement period of time.

The method 130 may further include one or more optional additional stages 137. For example, the one or more optional additional stages 137 may include operating, in response to the scheduled measurement period of time overlapping a first scheduled low-power period of time for an overlap period of time, the receiver in the active-power state during the overlap period of time without changing a scheduled timing of a second scheduled low-power period of time that is scheduled to occur subsequent to the first scheduled low-power period of time. The processor 20, for example, can modify a single cycle of the DRX cycle to ensure the wireless receiver 25 is in an active-power state during the scheduled measurement period of time. Even when the DRX cycle is modified, the wireless device 10 continues to operate in the DRX mode of operation. Examples of the alternative ways of modifying the DRX cycle are discussed below.

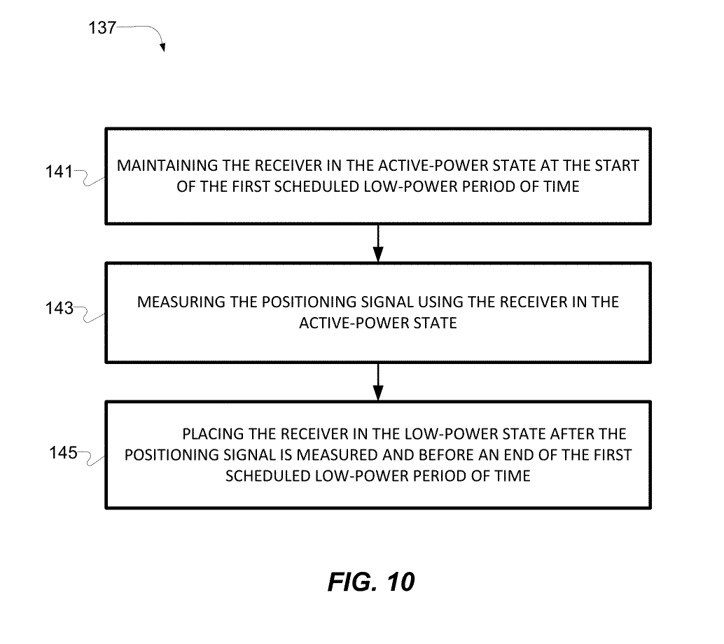

Referring to FIG. 10, with further reference to FIGS. 1-9, the one or more optional stages 137 of the method 130 may include the additional stages shown in response to determining that a start of the scheduled measurement period of time is scheduled to occur before an early threshold time after a start of the first scheduled low-power period of time.

At stage 141, the method 130 further includes maintaining the receiver in the active-power state at the start of the first scheduled low-power period of time. In connection with FIG. 5, stage 141 is illustrated by the first active-power period of time 62 being modified to be longer in duration than the first scheduled active-power period of time 52.

At stage 143, the method 130 further includes measuring the positioning signal using the receiver in the active-power state. Because the receiver was maintained in the active-power state at stage 141, the wireless receiver 25 is in the active-power state when the positioning signal is received. Thus, the wireless receiver 25 can receive and measure the positioning signal. For example, the time of arrival of the positioning signal may be determined using the clock 126 of the wireless receiver 25.

At stage 145, the method 130 further includes placing the receiver in the low-power state after the positioning signal is measured and before an end of the first scheduled low-power period of time. In connection with FIG. 5, stage 145 is illustrated by the first active-power period of time 62 ending and the first low-power period of time 63 beginning after the end time, t_{end}.

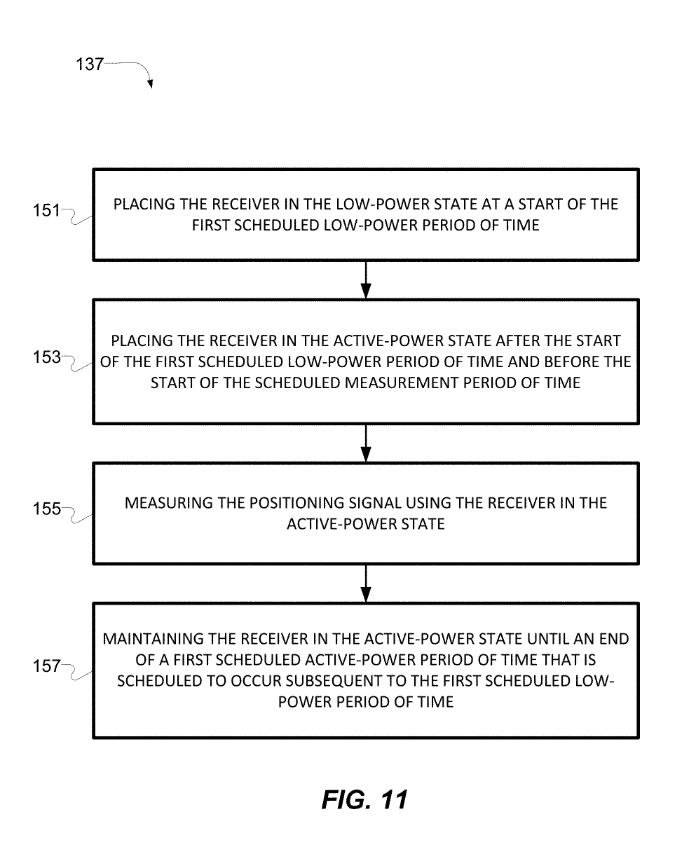

Referring to FIG. 11, with further reference to FIGS. 1-9, the one or more optional stages 137 of the method 130 may alternatively include the additional stages shown in response to determining that a start of the scheduled measurement period of time is scheduled to occur after a late threshold time before an end of the first scheduled low-power period of time.

At stage 151, the method 130 further includes placing the receiver in the low-power state at a start of the first scheduled low-power period of time. In connection with FIG. 6, stage 151 is illustrated by the active-power period of time 82 ending and the low-power period of time 83 beginning with no modification to the timing relative to the end of the first scheduled active-power period of time 72 and the beginning of the first scheduled low-power period of time 73.

At stage 153, the method 130 further includes placing the receiver in the active-power state after the start of the first scheduled low-power period of time and before the start of the scheduled measurement period of time. In connection with FIG. 6, stage 153 is illustrated by the first low-power period of time 83 ending before the end of the first scheduled low-power period of time 73, and the second active-power period of time 84 beginning before the beginning of the second scheduled active-power period of time 74.

At stage 155, the method 130 further includes measuring the positioning signal using the receiver in the active-power state. Because the receiver was placed in in the active-power state at stage 141 at a time earlier than originally scheduled, the wireless receiver 25 is in the active-power state when the positioning signal is received. Thus, the wireless receiver 25 can receive and measure the positioning signal. For example, the time of arrival of the positioning signal may be determined using the clock 126 of the wireless receiver 25.

At stage 157, the method 130 further includes maintaining the receiver in the active-power state until an end of a first scheduled active-power period of time that is scheduled to occur subsequent to the first scheduled low-power period of time. In connection with FIG. 6, stage 157 is illustrated by the second active-power period of time 84 not returning to a low-power state until the end of the second active-power period of time 84, which coincides with the end of the second scheduled active-power period of time 74.

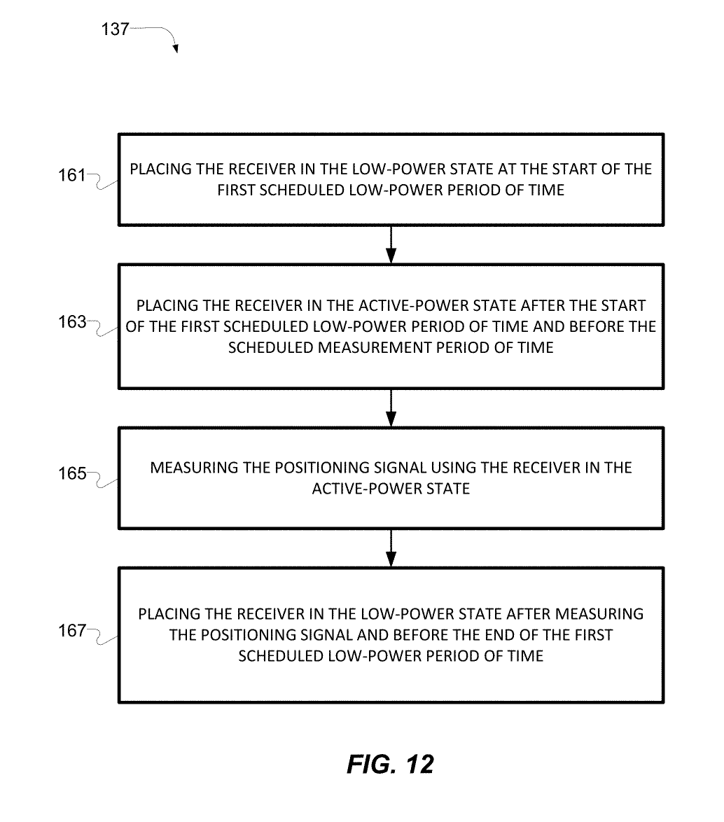

Referring to FIG. 12, with further reference to FIGS. 1-9, the one or more optional stages 137 of the method 130 may alternatively include the additional stages shown in response to determining that the scheduled measurement period of time is scheduled to occur after an early threshold time after a start of the first scheduled low-power period of time and before a late threshold time before an end of the first scheduled low-power period of time

At stage 161, the method 130 further includes placing the receiver in the low-power state at the start of the first scheduled low-power period of time. In connection with FIG. 7, stage 161 is illustrated by the first active-power period of time 102 ending and the first low-power period of time 103 beginning with no modification to the timing relative to the end of the first scheduled active-power period of time 92 and the beginning of the first scheduled low-power period of time 93.

At stage 163, the method 130 further includes placing the receiver in the active-power state after the start of the first scheduled low-power period of time and before the scheduled measurement period of time. In connection with FIG. 7, stage 163 is illustrated by the first low-power period of time 103 ending before the end of the first scheduled low-power period of time 93, and the additional active-power period of time 105 beginning before the beginning of the second scheduled active-power period of time 94.

At stage 165, the method 130 further includes measuring the positioning signal using the receiver in the active-power state. Because the receiver was placed in in the active-power state at stage 163 at a time earlier than originally scheduled, the wireless receiver 25 is in the active-power state when the positioning signal is received. Thus, the wireless receiver 25 can receive and measure the positioning signal. For example, the time of arrival of the positioning signal may be determined using the clock 126 of the wireless receiver 25.

At stage 167, the method 130 further includes placing the receiver in the low-power state after measuring the positioning signal and before the end of the first scheduled low-power period of time. In connection with FIG. 7, stage 167 is illustrated by the additional active-power period of time 105 ending and the additional low-power period of time 106 beginning at a time that is during the first scheduled low-power period of time 93.

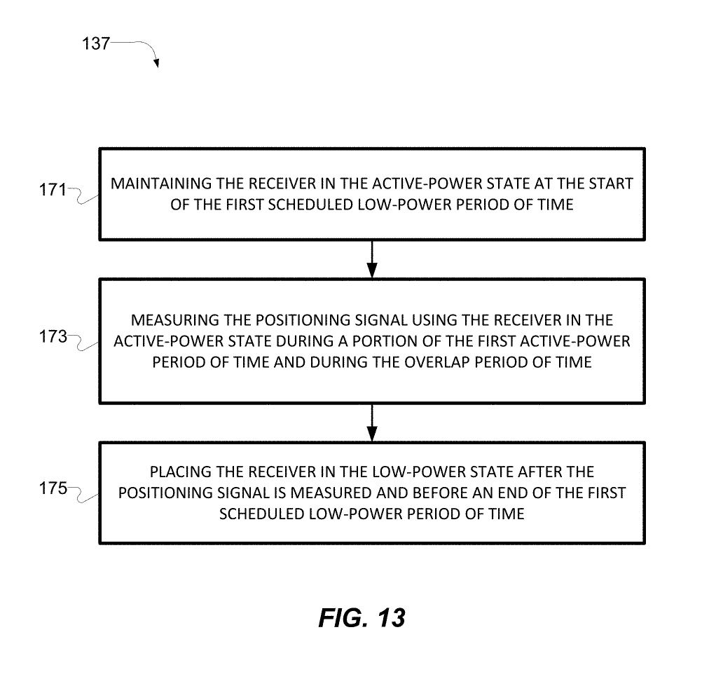

Referring to FIG. 13, with further reference to FIGS. 1-9, the one or more optional stages 137 of the method 130 may alternatively include the additional stages shown in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time.

At stage 171, the method 130 further includes maintaining the receiver in the active-power state at the start of the first scheduled low-power period of time. In connection with FIG. 8, stage 171 is illustrated by the first active-power period of time 122 being modified to be longer in duration than the first scheduled active period of time 112.

At stage 173, the method 130 further includes measuring the positioning signal using the receiver in the active-power state during a portion of the first active-power period of time and during the overlap period of time. Because the receiver was maintained in the active-power state at stage 171, the wireless receiver 25 is in the active-power state when the positioning signal is received. Thus, the wireless receiver 25 can receive and measure the positioning signal. For example, the time of arrival of the positioning signal may be determined using the clock 126 of the wireless receiver 25.

At stage 175, the method 130 further includes placing the receiver in the low-power state after the positioning signal is measured and before an end of the first scheduled low-power period of time. In connection with FIG. 8, stage 175 is illustrated by the first active-power period of time 122 ending and the first low-power period of time 123 beginning after the end time, t_{end}.

As discussed in connection with the above alternative techniques for modifying the DRX cycle, the method 130 may include operating the receiver in the active-power state during the scheduled low-power period of time, and measuring the positioning signal using the receiver in the active-power state during the scheduled low-power period of time.

The method of operating the wireless device may further include correcting an error in a clock of the receiver after placing the receiver in the active-power state. For example, correcting errors in the clock 26 may be done when the wireless receiver 25 is placed in the active-power state after being in the low-power state. For example, after controlling the wireless receiver 25 to enter the active power state, the processor 20 may correct the error in the clock 26 according to the clock-error correction techniques described in U.S. Pat. No. 9,461,684, entitled “Fast system recovery in multi-radio-access-technology devices,” U.S. Pat. No. 6,735,454, entitled “Method and apparatus for activating a high frequency clock following a sleep mode within a mobile station operating in a slotted paging mode,” and U.S. Pat. No. 6,453,181, entitled “Method and apparatus for compensating for frequency drift in a low frequency sleep clock within a mobile station operating in a slotted paging mode,” each of which is incorporated herein by reference in their entirety. The error in the clock 26 may be a timing error or a frequency error. Using the aforementioned clock-error correction techniques, the clock errors can be extrapolated based on the amount of time the clock 26 was off (e.g., the duration of the low-power phase of the DRX cycle). For example, timing errors can be determined by characterizing the timing error when the clock 26 is on and extrapolate the timing error for periods of time when the clock 26 is off based on the previous characterization of the timing errors. In response to determining the timing error, the time of the clock 26 is corrected based on the timing error. Also using the aforementioned clock-error correction techniques, the frequency error of the clock 26 can be corrected. For example, the processor 20 may maintain a current frequency error for the clock 26 at all times (e.g., during the active-power state and the low-power state). The current frequency error may be referred to as the Recent Good System (RGS), which also stores a reference temperature for when the current frequency error was determined. The RGS may be maintained by a software component in memory 21 known as the Temperature Control Oscillator (TCXO) Manager (TCXOMGR). The wireless receiver 25 periodically reports the current frequency error and the current temperate to the TCXOMGR. The frequency error seen by clocks using crystal oscillators is characterized by the equation:

f(t)=c₃(t−t₀)³+c₂(t−t₀)²+c₁(t−t₀)+c₀,

where c₃, c₂, c₁ and c₀ are coefficients determined from a previous device calibration, t₀ is the reference temperature of the clock 26 from the Recent Good System, and t is the current temperature of the clock 26. If there is a temperature variation between a current time and the reference temperature stored in the RGS, the TCXOMGR extrapolates the frequency error using the above equation. In the example of a DRX cycle, the temperature measurement made when the clock 26 was last on (e.g., the RGS temperature) is compared to the temperature of the clock 26 after waking up from the low-power state. If there is a difference between the RGS temperature and the temperature upon waking up, then the frequency error is corrected by the processor 20.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless network is a communication system in which communications are conveyed wirelessly, i.e., by electromagnetic and/or acoustic waves propagating through atmospheric space rather than through a wire or other physical connection. A wireless network may not have all communications transmitted wirelessly, but is configured to have at least some communications transmitted wirelessly. Further, the term “wireless device,” or similar term, does not require that the functionality of the device is exclusively, or evenly primarily, for wireless communication, or that the device be a mobile device, but indicates that the device includes wireless communication capability (one-way or two-way), e.g., includes at least one radio (each radio being part of a transmitter, receiver, or transceiver) for wireless communication.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The term “processor-readable storage medium,” as used herein, refer to any medium that participates in providing data that causes a processor to operate in a specific fashion. Using a computer system, various processor-readable storage media might be involved in providing instructions/code to processor(s) for execution and/or might be used to store and/or carry such instructions/code (e.g., as signals). In many implementations, a processor-readable storage medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible processor-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of processor-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory processor-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

1. A method of operating a wireless device, the method comprising:
determining, using a processor of the wireless device, to operate the wireless device in a discontinuous reception (DRX) mode of operation such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state;
scheduling, using the processor of the wireless device, a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and
operating the wireless device in the DRX mode of operation after scheduling the measurement and through at least the scheduled measurement period of time.

2. The method of claim 1, wherein the scheduled low-power period of time is a first scheduled low-power period of time, the method further comprising operating, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time.

3. The method of claim 2, further comprising, in response to determining that a start of the scheduled measurement period of time is scheduled to occur before an early threshold time after a start of the first scheduled low-power period of time:
maintaining the receiver in the active-power state at the start of the first scheduled low-power period of time;
measuring the positioning signal using the receiver in the active-power state; and
placing the receiver in the low-power state after the positioning signal is measured and before an end of the first scheduled low-power period of time.

4. The method of claim 2, further comprising, in response to determining that a start of the scheduled measurement period of time is scheduled to occur after a late threshold time before an end of the first scheduled low-power period of time:
placing the receiver in the low-power state at a start of the first scheduled low-power period of time;
placing the receiver in the active-power state after the start of the first scheduled low-power period of time and before the start of the scheduled measurement period of time;
measuring the positioning signal using the receiver in the active-power state; and
maintaining the receiver in the active-power state until an end of a first scheduled active-power period of time that is scheduled to occur subsequent to the first scheduled low-power period of time.

5. The method of claim 2, further comprising, in response to determining that the scheduled measurement period of time is scheduled to occur after an early threshold time after a start of the first scheduled low-power period of time and before a late threshold time before an end of the first scheduled low-power period of time:
placing the receiver in the low-power state at the start of the first scheduled low-power period of time;
placing the receiver in the active-power state after the start of the first scheduled low-power period of time and before the scheduled measurement period of time;
measuring the positioning signal using the receiver in the active-power state; and
placing the receiver in the low-power state after measuring the positioning signal and before the end of the first scheduled low-power period of time.

6. The method of claim 2, further comprising, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time:
maintaining the receiver in the active-power state at the start of the first scheduled low-power period of time;
measuring the positioning signal using the receiver in the active-power state during a portion of the first scheduled active-power period of time and during the overlap period of time; and
placing the receiver in the low-power state after the positioning signal is measured and before an end of the first scheduled low-power period of time.

7. The method of claim 1, further comprising:
operating the receiver in the active-power state during the scheduled low-power period of time; and
measuring the positioning signal using the receiver in the active-power state during the scheduled low-power period of time.

8. The method of claim 7, further comprising correcting an error in a clock of the receiver after placing the receiver in the active-power state.

9. A wireless device for receiving positioning signals, comprising:
a receiver configured to:
operate in a low-power state;
operate in an active-power state, wherein the receiver will use more power in the active-power state than in the low-power state; and
receive signals when operating in the active-power state; and
a processor coupled to the receiver, the processor configured to:
determine to operate the wireless device in a discontinuous reception (DRX) mode of operation such that the receiver is expected to operate in the low-power state during a scheduled low-power period of time and the receiver is expected to operate in the active-power state during a scheduled active-power period of time;
schedule a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and
operate the wireless device in the DRX mode of operation after scheduling the measurement and through at least the scheduled measurement period of time.

10. The wireless device of claim 9, wherein:
the scheduled low-power period of time is a first scheduled low-power period of time; and
the processor is further configured to operate, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time.

11. The wireless device of claim 10, wherein the processor is further configured to respond to determining that a start of the scheduled measurement period of time is scheduled to occur before an early threshold time after a start of the first scheduled low-power period of time by:
maintaining the receiver in the active-power state at the start of the first scheduled low-power period of time;
measuring the positioning signal using the receiver in the active-power state; and
placing the receiver in the low-power state after the positioning signal is measured and before an end of the first scheduled low-power period of time.

12. The wireless device of claim 10, wherein the processor is further configured to respond to determining that a start of the scheduled measurement period of time is scheduled to occur after a late threshold time before an end of the first scheduled low-power period of time by:
placing the receiver in the low-power state at a start of the first scheduled low-power period of time;
placing the receiver in the active-power state after the start of the first scheduled low-power period of time and before the start of the scheduled measurement period of time;
measuring the positioning signal using the receiver in the active-power state; and
maintaining the receiver in the active-power state until an end of a first scheduled active-power period of time that is scheduled to occur subsequent to the first scheduled low-power period of time.

13. The wireless device of claim 10, wherein the processor is further configured to respond to determining that the scheduled measurement period of time is scheduled to occur after an early threshold time after a start of the first scheduled low-power period of time and before a late threshold time before an end of the first scheduled low-power period of time:
placing the receiver in the low-power state at the start of the first scheduled low-power period of time;
placing the receiver in the active-power state after the start of the first scheduled low-power period of time and before the scheduled measurement period of time;
measuring the positioning signal using the receiver in the active-power state; and
placing the receiver in the low-power state after measuring the positioning signal and before the end of the first scheduled low-power period of time.

14. The wireless device of claim 10, wherein the processor is further configured to respond to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time by:
maintaining the receiver in the active-power state at the start of the first scheduled low-power period of time;
measuring the positioning signal using the receiver in the active-power state during a portion of the first scheduled active-power period of time and during the overlap period of time; and
placing the receiver in the low-power state after the positioning signal is measured and before an end of the first scheduled low-power period of time.

15. The wireless device of claim 9, wherein the processor is further configured to:
operate the receiver in the active-power state during the scheduled low-power period of time; and
measure the positioning signal using the receiver in the active-power state during the scheduled low-power period of time.

16. The wireless device of claim 15, wherein the processor is further configured to correct an error in a clock of the receiver after placing the receiver in the active-power state.

17. A wireless device for receiving positioning signals, comprising:
means for determining to operate the wireless device in a discontinuous reception (DRX) mode of operation such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state;
means for scheduling a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and
means for operating the wireless device in the DRX mode of operation after scheduling the measurement and through at least the scheduled measurement period of time.

18. The wireless device of claim 17, wherein the scheduled low-power period of time is a first scheduled low-power period of time, the wireless device further comprising means for operating, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time.

19. The wireless device of claim 18, wherein the means for operating the receiver are further for, in response to determining that a start of the scheduled measurement period of time is scheduled to occur before an early threshold time after a start of the first scheduled low-power period of time:
maintaining the receiver in the active-power state at the start of the first scheduled low-power period of time;
measuring the positioning signal using the receiver in the active-power state; and
placing the receiver in the low-power state after the positioning signal is measured and before an end of the first scheduled low-power period of time.

20. The wireless device of claim 18, wherein the means for operating the receiver are further for, in response to determining that a start of the scheduled measurement period of time is scheduled to occur after a late threshold time before an end of the first scheduled low-power period of time:
placing the receiver in the low-power state at a start of the first scheduled low-power period of time;
placing the receiver in the active-power state after the start of the first scheduled low-power period of time and before the start of the scheduled measurement period of time;
measuring the positioning signal using the receiver in the active-power state; and
maintaining the receiver in the active-power state until an end of a first scheduled active-power period of time that is scheduled to occur subsequent to the first scheduled low-power period of time.

21. The wireless device of claim 18, wherein the means for operating the receiver are further for, in response to determining that the scheduled measurement period of time is scheduled to occur after an early threshold time after a start of the first scheduled low-power period of time and before a late threshold time before an end of the first scheduled low-power period of time:
placing the receiver in the low-power state at the start of the first scheduled low-power period of time;
placing the receiver in the active-power state after the start of the first scheduled low-power period of time and before the scheduled measurement period of time;
measuring the positioning signal using the receiver in the active-power state; and
placing the receiver in the low-power state after measuring the positioning signal and before the end of the first scheduled low-power period of time.

22. The wireless device of claim 18, wherein the means for operating the receiver are further for, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time:
maintaining the receiver in the active-power state at the start of the first scheduled low-power period of time;
measuring the positioning signal using the receiver in the active-power state during a portion of the first scheduled active-power period of time and during the overlap period of time; and
placing the receiver in the low-power state after the positioning signal is measured and before an end of the first scheduled low-power period of time.

23. The wireless device of claim 17, further comprising:
means for operating the receiver in the active-power state during the scheduled low-power period of time; and
means for measuring the positioning signal using the receiver in the active-power state during the scheduled low-power period of time.

24. A non-transitory, processor-readable storage medium comprising processor-readable instructions configured to cause a processor of a mobile device to:
determine to operate the wireless device in a discontinuous reception (DRX) mode of operation such that a receiver of the wireless device is expected to operate in a low-power state during a scheduled low-power period of time and the receiver is expected to operate in an active-power state during a scheduled active-power period of time, wherein the receiver will use more power in the active-power state than in the low-power state;
schedule a measurement of a positioning signal using the receiver, wherein the measurement is scheduled to occur during a scheduled measurement period of time, wherein the scheduled measurement period of time at least partially overlaps with at least one of the scheduled low-power period of time or the scheduled active-power period of time; and
operate the wireless device in the DRX mode of operation after scheduling the measurement and through at least the scheduled measurement period of time.

25. The non-transitory, processor-readable storage medium of claim 24, wherein the scheduled low-power period of time is a first scheduled low-power period of time, the non-transitory, processor-readable storage medium further comprising instructions configured to cause the processor to operate, in response to the scheduled measurement period of time overlapping the first scheduled low-power period of time for an overlap period of time, the receiver in the active-power state during the overlap period of time without changing a scheduled timing of a second scheduled low-power period of time that is scheduled to occur subsequent to the first scheduled low-power period of time.

26. The non-transitory, processor-readable storage medium of claim 25, further comprising instructions configured to cause the processor to, in response to determining that a start of the scheduled measurement period of time is scheduled to occur before an early threshold time after a start of the first scheduled low-power period of time:
maintain the receiver in the active-power state at the start of the first scheduled low-power period of time;
measure the positioning signal using the receiver in the active-power state; and
place the receiver in the low-power state after the positioning signal is measured and before an end of the first scheduled low-power period of time.

27. The non-transitory, processor-readable storage medium of claim 25, further comprising instructions configured to cause the processor to, in response to determining that a start of the scheduled measurement period of time is scheduled to occur after a late threshold time before an end of the first scheduled low-power period of time:
place the receiver in the low-power state at a start of the first scheduled low-power period of time;
place the receiver in the active-power state after the start of the first scheduled low-power period of time and before the start of the scheduled measurement period of time;
measure the positioning signal using the receiver in the active-power state; and
maintain the receiver in the active-power state until an end of a first scheduled active-power period of time that is scheduled to occur subsequent to the first scheduled low-power period of time.

28. The non-transitory, processor-readable storage medium of claim 25, further comprising instructions configured to cause the processor to, in response to determining that the scheduled measurement period of time is scheduled to occur after an early threshold time after a start of the first scheduled low-power period of time and before a late threshold time before an end of the first scheduled low-power period of time:
place the receiver in the low-power state at the start of the first scheduled low-power period of time;
place the receiver in the active-power state after the start of the first scheduled low-power period of time and before the scheduled measurement period of time;
measure the positioning signal using the receiver in the active-power state; and
place the receiver in the low-power state after measuring the positioning signal and before the end of the first scheduled low-power period of time.

29. The non-transitory, processor-readable storage medium of claim 25, further comprising instructions configured to cause the processor to, in response to determining that a start of the scheduled measurement period of time is scheduled to occur during a first scheduled active-power period of time before a start of the first scheduled low-power period of time and that an end of the scheduled measurement period of time is scheduled to occur after the start of the first scheduled low-power period of time:
maintain the receiver in the active-power state at the start of the first scheduled low-power period of time;
measure the positioning signal using the receiver in the active-power state during a portion of the first scheduled active-power period of time and during the overlap period of time; and
place the receiver in the low-power state after the positioning signal is measured and before an end of the first scheduled low-power period of time.

30. The non-transitory, processor-readable storage medium of claim 24, further comprising instructions configured to cause the processor to:
operate the receiver in the active-power state during the scheduled low-power period of time; and
measure the positioning signal using the receiver in the active-power state during the scheduled low-power period of time.
